(19) United States
(12) Patent Application Publication
(10) Pub. No.: US 2026/0336571 A1
(43) Pub. Date: Oct. 29, 2026

(54) Safety device and washing portal

(71) Applicant: WASHTEC HOLDING GMBH, Augsburg (DE)

(72) Inventor: Sven Brudniok, Langerringen (DE)

(73) Assignee: WASHTEC HOLDING GMBH, Augsburg (DE)

(21) Appl. No.: 19/637,182

(22) Filed: Apr. 2, 2026

(30) Foreign Application Priority Data
Apr. 23, 2025 (EP) 25172012.4

(51) Int. Cl. B60S 3/04; B08B 13/00

(52) U.S. Cl. CPC B60S 3/04; B08B 13/00

(57) ABSTRACT

The invention relates to a safety device for a portal car wash with a washing portal that can be moved along a direction of movement. The device comprises a first and a second collision detection device, each of which contains a collision element and a detector device. The detector devices are mechanically coupled to the collision elements and are designed to allow horizontal displacement of the collision elements when force is applied and to detect this movement. At least one coupling element connects the two collision elements in a mechanically movable manner and transmits a mechanical force acting on the coupling element at least partially to one or both collision elements. This allows a collision to be detected both directly at the collision elements and at the coupling element, enabling early detection of obstacles or persons in the movement range of the washing portal.

### CROSS REFERENCE TO RELATED APPLICATIONS

This application claims priority to European patent application 25172012.4, filed on Apr. 23, 2025, the content of which is hereby incorporated in its entirety as if fully set forth herein.

### TECHNICAL FIELD

The present invention relates to a safety device for a rollover car wash. The safety device is designed for early detection of a collision between portal of the rollover car wash and an object, in particular a person. In addition, the invention relates to a washing portal equipped with such a safety device and a rollover car wash.

### BACKGROUND

Rollover car washers are automated devices for cleaning vehicles, in which the vehicle remains stationary during the washing process. The washing portal, in particular a movable frame structure, moves along the stationary vehicle and performs the various cleaning steps. The vehicle is first driven into the system and parked in a designated position. The driver turns off the engine, leaves the vehicle, and steps out of the area where the vehicle is parked. As a rule, the washing process is then started from outside.

Due to the limited space available, people are not allowed to remain in the washing area during operation. In many systems, this is expressly prohibited for safety reasons.

During the washing process, collisions between the moving washing portal and objects, especially living beings or objects, must be prevented. Particularly critical situations can arise if objects are unexpectedly present in the washing area or if persons enter the area without authorization.

Various solutions are already known for preventing collisions between the washing portal and a vehicle or vehicle parts, such as protruding side mirrors or similar attachments.

A collision detection system is known from DE 10 2022 102 613 A1. This application describes a safety device with a pendulum-like collision bar that can detect a collision with an object. The bar is arranged on the washing portal in such a way that it detects a collision in advance, before the (actual) washing portal hits the object. This is intended to stop the washing portal in time to prevent a collision between the portal itself and the detected object.

Conventional collision detection systems are primarily designed to detect collisions with objects. In particular, these systems often monitor for collisions toward the inside of the washing portal, i.e., the side facing the vehicle to be cleaned. This is particularly advantageous for detecting collisions with vehicle attachments such as exterior mirrors. However, such a system cannot provide comprehensive personal protection.

If there is another object or even a person next to the vehicle or in another area of the working space, especially on the outside of the washing portal, such systems reach their limits. Since they are primarily focused on the area between the washing portal and the vehicle, they offer only limited possibilities for detecting collisions with other objects or persons outside this area.

In particular, conventional systems are only suitable for personal protection to a limited extent. Critical situations can arise if a person re-enters the working area after the washing process has started, for example to close an open window or retrieve an object from the vehicle. In such cases, there is a risk that the moving washing portal will collide with the person without the existing safety systems being able to detect the danger in time and react to it.

### SUMMARY

Based on this, it is an object of the present invention to improve the safety concept of a rollover car wash, in particular with regard to the protection of persons. For this purpose, a safety device is to be provided which can prevent collisions not only with objects attached to the vehicle, but also, in particular, with persons.

According to a first aspect, the object is solved by a safety device for a rollover car wash, a washing portal with such a safety device, and a rollover car wash according to the features of the independent patent claims. Advantageous embodiments are the subject of the dependent patent claims.

The safety device proposed here is intended in particular for a washing portal that can be moved along an axis of movement in two directions (forward and backward). The safety device can be designed in particular to detect a potential or imminent collision between a collision body and the washing portal in advance in order to prevent an actual collision with the washing portal. This is made possible by detecting a collision between the collision body and the safety device in the event of a collision in order to prevent a collision between the collision body and the washing portal.

The proposed solution makes it possible to extend the monitoring area beyond the direct vehicle contour so that unexpected situations can also be detected, for example, if a person re-enters the working area after the washing process has started.

Such a safety device can significantly improve personal safety, especially during operation of the rollover car wash, and reduce the risk of collisions with the moving washing portal.

The collision body can be a specific object (e.g., an object separate from the vehicle, such as a canister, or an object that is a movable component of the vehicle, such as an open vehicle door) or a living being (human or animal). In particular, the safety device serves to protect people.

The safety device comprises a first collision detection device, a second collision detection device, and at least one coupling element.

The first collision detection device comprises a first collision element and a first detector device. The first detector device is mechanically coupled to the first collision element. It is designed to enable a preferably horizontal displacement (lateral displacement and/or pivoting or rotation) of the first collision element when a mechanical force is applied to it. It also detects the force applied to the first collision element.

The second collision detection device comprises a second collision element and a second detector device. The second detector device is mechanically coupled to the second collision element. It is designed to enable a preferably horizontal displacement of the second collision element against the direction of movement of the washing portal when a mechanical force is applied on the second collision element. It also detects the force applied on the second collision element.

The term “horizontal displacement” of the first and/or second (in particular vertically arranged) collision element (and in particular the claim wording: “a preferably horizontal displacement of the second collision element against the direction of movement of the washing portal”) means the following here:

When a mechanical force acts on the first collision element or another component of the safety device due to collision with a collision body, the first collision element is mechanically coupled to the first detector device in such a way that the first collision element can move in a horizontal plane (change in the X and/or Y coordinates of the collision element in the top view) while the height position of the collision element (Z coordinate) remains essentially constant. “Essentially” here means that an insignificant movement in the Z axis (vertical axis) occurs due to the pendulum suspension of the first collision element during a pendulum movement; however, this is negligible relative to the horizontal movement.

When a mechanical force acts on the second collision element or another component of the safety device due to collision with a collision body, the second collision element is mechanically coupled to the second detector device in such a way that the second collision element can move in a horizontal plane (change in the X and/or Y coordinates of the collision element in the top view) while the height position of the collision element (Z coordinate) remains essentially constant (here, too, “essentially” means that the vertical movement is negligible in relation to the horizontal movement).

The first and/or second detector device is preferably fixedly or rigidly connected to the washing portal and designed to enable and detect relative movement of the first and/or second collision element or the first and/or second slider element with respect to the washing portal. A sensor element may be part of the detector device. The detector device may have several components. The components of the detector device may be arranged on different parts of the washing portal and/or the safety device.

A first/second slider element may be provided which is fixedly or rigidly attached to the first or second collision element and/or can move relative to the first and/or second detector device, whereby this relative movement is detected by the respective sensor element. The respective slider element is movably mounted via at least one bearing element (e.g., pin) in a guide device and/or guided in this guide device of the first and/or second detector device. The relative movement can preferably be effected by a linear displacement of the slider element of the first and/or second detector device relative to the guide device of the first and/or second collision detection device. Alternatively or cumulatively, the relative movement can be effected by a rotation of the slider element about a bearing element, for example a pin.

In the event of a collision, the first and/or second collision element experiences an external force, causing the slider element to move relative to the guide device of the detector device and/or to the detector device. This relative movement is detected by the sensor. The collision force acting on the slider element is not transmitted directly to the detector device, as this is rigidly or firmly attached to the washing portal (or its frame). Instead, the force is transmitted via the slider element, which is coupled to the detector device via the bearing element, preferably a pin. Preferably, the force is transmitted via the slider element to a reset device. The force transmitted to the slider element by a collision thus leads, for example, to a displacement of a weight which, as a reset weight, forms a reset force of the reset device.

The guide device in the detector device serves to guide the slider element and can enable the first and/or second collision element to be deflected. The guide device can be designed as a linear guide, for example in the form of a drawer guide with sliding or rolling elements, or as a pivot joint for the targeted rotation of the connecting element, or as a combination of the two (e.g., a drawer guide that can also be rotated about a pivot joint). Alternatively, it may comprise any other known mechanical guide that allows translational and/or rotational relative movement of a counterpart, in particular the connecting element, for example a sliding guide or a combined sliding-rotary guide.

The coupling element can rotate around the axis of the first collision element. The coupling element can move laterally in a coupling point for the second collision element in an axis of the coupling element and rotate around the axis of the second collision element. The slider element can rotate independently around the axis of the first or second bearing element.

The slider element can preferably be designed as a linearly displaceable element or, alternatively or cumulatively, as a rotatable element that can rotate around a bearing element, for example a pin. This enables reliable detection of different collision scenarios.

The slider element is guided by the bearing element so that it can be displaced and/or rotated. Lateral displacement of the slider element relative to the bearing element or rotation of the slider element relative to the bearing element is therefore possible.

The guide device can be designed as a slide guide or, alternatively or cumulatively, as a rotary guide in order to guide the relative movement of the slider element.

The coupling element is mechanically coupled to the first collision element and the second collision element in such a way that a movement of the coupling element also moves the first collision element and/or the second collision element, without exerting a force on either the first collision element or the second collision element that would cause the guide to jam at the respective detection device.

The at least one coupling element is mechanically coupled to the first and second collision elements. It is movably connected to the first and second collision elements. Alternatively or additionally, it is designed to transfer at least part of a mechanical force acting on the coupling element to the first collision element and/or the second collision element.

According to the present invention, the force exerted by the collision is considered to be the triggering factor for the movement of the slider element. However, the actual direction of movement of the force cannot be determined solely from the collision force, but from the sum of all forces acting. These include, in particular, a reset force acting on the slider element, frictional forces at the contact surfaces as a result of relative movements, and guiding forces of the slider element. Due to this distribution of forces, in most cases either a linear displacement or a rotational movement, e.g., around the pin, results. In this context of mechanical force transmission, the term “essentially” is regarded as the sum of all forces acting.

Advantageously, one or more simultaneous collisions can be detected by the safety device, whereby the force acting on the safety device then results from the sum of the individual collision forces.

According to a further aspect, a washing portal with a safety device according to the invention is provided. The washing portal may comprise two vertical supports (also referred to as portal columns or columns). A safety device according to the invention may be provided on each of the supports.

According to yet another aspect, a rollover car wash with a safety device according to the invention is provided.

The safety device can be fixed or removably attached to a portal column of the washing portal as a frame or scaffold-like structure. The safety device can comprise several separate components. The safety device may comprise components that are fixed in position relative to the portal column and components that are movable in position. Preferably, the safety device is fixedly attached to a front side, as viewed in the direction of movement, and/or to a rear side on an outer surface of the portal column.

The safety device serves to detect collisions with a collision body in order to prevent the collision body from colliding with the washing portal.

The safety device comprises a first collision detection device with a first collision element and a first detector device. The first collision element can be arranged, as seen in a front view, on an inner edge (i.e., the side facing the vehicle to be cleaned) of the portal column, in particular in alignment with this inner edge. The first collision detection device is arranged in the safety device so that it can be moved relative to the first detection device.

The safety device comprises a second collision detection device with a second collision element and a second detection device. The second collision element can be arranged, as seen in a front view, on an outer edge (i.e., the side facing away from the vehicle to be cleaned) of the portal column, in particular in alignment with this outer edge. The second collision detection device is movably arranged in the safety device relative to the second detection device.

The second collision element and the first collision element are preferably arranged parallel to each other.

The second collision element and/or the first collision element is preferably aligned vertically in a rest position (i.e., without external force).

Alternatively or additionally, the safety device comprises at least one coupling element, preferably two coupling elements. The at least one coupling element is preferably designed to be approximately horizontal and is mechanically coupled to the first and second collision elements. The height at which the at least one coupling element is attached can be variably adjusted to the operating situation of the rollover car wash. Preferably, the height is determined by expected collisions.

The design of the safety device makes it possible to cover the entire area of the front of a car washing portal column, including a first outer area and a second outer area, which extend inwards and outwards across the width of the car washing portal, in terms of safety (or to protect them from collisions). This means that the entire working area of the car washing portal can be covered in terms of safety.

Preferably, the first and second collision detection devices can have a different design so that the safety device can be designed to be quasi-asymmetrical with respect to the two collision detection devices.

Alternatively, the first and second collision detection devices may have a corresponding or identical structure, so that the safety device can be designed to be virtually symmetrical with respect to the two collision detection devices.

Preferably, the safety device is arranged on at least one front side in the direction of movement of the washing portal.

A rollover car wash (hereinafter also referred to as “system”) within the meaning of the present invention is an automated cleaning device for vehicles, in which the vehicle can remain stationary, in particular during the entire washing process. The washing portal, which serves as the central movable unit of the system, moves along the predominantly stationary vehicle or relative to the vehicle and performs the individual cleaning steps.

The vehicles can be road or rail vehicles. The vehicles can be, in particular, passenger cars, trucks, or trains.

A washing portal within the meaning of the present invention may comprise two (predominantly vertical) portal columns and a bridge connecting them. The washing portal may have the shape of an inverted U when viewed from the front. Alternatively or additionally, a supporting frame structure may typically be provided, on which various cleaning devices, such as rotating brushes, nozzles, in particular high-pressure nozzles, or other washing units, are arranged. During the washing process, the washing portal moves along a defined direction of movement at a defined (possibly varying) speed over or relative to the vehicle to ensure complete cleaning.

Due to its design, a washing portal has a considerable mass, which, depending on the design, can amount to many hundreds of kilograms and in some cases even reach two tons or more. Accordingly, powerful drives are required for its movement, which move the portal along the direction of movement.

When braking a washing portal that is in motion, a stopping distance that cannot be ignored is created, as the mass of the portal causes considerable inertia. To avoid a collision with an object in the working area, such an object must be detected at an early stage. Only in this way can the stopping process be initiated within the available stopping distance and the washing portal be stopped in time, especially before colliding with the collision object.

The working space is defined as a space or area in the vicinity of the system. The working space can extend in particular between the two portal columns and/or outside and/or in front of or behind at least one of the two portal columns. Since the washing portal moves, the working space also extends into the movement range (or travel range) of the washing portal. This enables the detection of a collision body inside and/or outside the range of the washing portal. The detection of a collision body takes place in particular in a spatial detection area. The detection area can thus be in particular a space that is larger than a space extending over a base area of the washing portal in the top view. For example, the detection area can also include areas outside the washing portal or its portal columns.

Particular attention must be paid to the risk of collision between the washing portal and a collision body, in particular a living being, especially a person. On the one hand, such a collision can cause serious injury. On the other hand, the collision behavior of a person differs significantly from that of a collision with vehicle parts or other objects.

While protruding vehicle parts, such as mirrors, are typically located within a limited area on the side of the washing portal facing the vehicle, a person can be located in a wide variety of places. A collision can occur not only in the interior between the washing portal and the vehicle, but also on the outside of the washing portal, i.e., on a side facing away from the vehicle. In addition, a person may also be standing directly in front of the movable portal. Advantageously, all of these collision scenarios are covered by the solution presented here.

Another feature of detecting people, as opposed to components or objects of the vehicle or the car wash itself, concerns the height of the possible collision. While vehicle parts are usually within a predictable height range, a person can collide with the washing portal at very different heights. For example, a standing person can stretch out an arm and thereby trigger a collision in a higher area, for example at a height of 1.5 m. It is also possible that a person has fallen and is lying on the ground, which could result in a collision at a very low height. It must also be possible to reliably detect persons who are sitting or lying down (e.g., children), which can be ensured with the safety device proposed here.

In addition, one or more persons may move during the washing process, for example due to panic or shock. This means that the exact point of collision with the washing portal cannot be reliably predicted. This places additional demands on a safety device, which must be able to detect collisions at an early stage regardless of their position.

The safety device is preferably spaced apart from the front of the portal, in particular the portal column. The distance is chosen so that between the time of collision detection and the completion of the stopping process of the washing portal after detection of a collision, complete deceleration (to a standstill) of the portal can be ensured without leading to a collision between the colliding object and the (actual) washing portal (not its safety device).

The conditions surrounding a car wash are usually demanding. Dirt, moisture, and washing fluids can impair the function of optical sensors, such as light barriers or camera systems, or even make their use completely impossible. Therefore, mechanical collision detection using leading collision elements is a particularly suitable solution.

Such a collision element can trigger a mechanical event, such as movement of the collision element, when it comes into contact with a collision body, e.g., an object or a person. This event can be detected by a suitable detector device in order to initiate the stopping process of the car washing portal.

However, the use of individual collision elements results in a restriction in the monitoring area. A single collision element can only cover a limited area. For example, a vertical collision element of a certain width can only monitor the area in front of the collision element within that specific width for collisions. If, for example, a person is standing to the side of the collision element, he or she cannot be detected by it without the coupling element design according to the invention. Even if several (e.g., vertical) collision elements are used, monitoring remains limited to certain locations resulting from the arrangement (and width) of the collision elements. This can have a negative effect on the reliability of collision detection for persons, since the exact location of the collision cannot be predicted due to the aforementioned movement possibilities of a person.

The longitudinal axis of the collision elements preferably extends vertically. The collision elements are arranged in particular parallel to each other. The collision elements are preferably rounded at their lower ends in particular.

One idea of the present invention is to provide at least one coupling element in addition to several, preferably two, collision elements. A longitudinal axis of the coupling element preferably runs horizontally and/or perpendicular to the collision elements.

The coupling element mechanically connects the collision elements to each other. This means that not only is a collision detected that occurs directly on one of the collision elements or, when viewed from the front, in an area in front of the collision element, but a collision with the coupling element itself can also be detected. Alternatively or additionally, the coupling element can also detect a collision between the (vertical) collision elements and/or, when viewed from the front, next to the (vertical) collision elements, i.e., inside and/or outside the (vertical) collision elements of the washing portal. The coupling element is preferably rounded at the ends.

In the event of a collision with the coupling element, a mechanical force is essentially transmitted to at least one of the collision elements. The effect of the mechanical force, which is caused in particular by the collision of the safety device with a collision body, can then be detected at this collision element, whereby a collision is registered.

In this way, the coupling element extends the monitoring range of the safety device. While conventional solutions only allow detection directly at the collision elements, the arrangement according to the invention also allows a collision to be detected that occurs between these collision elements or outside them.

The collision detection devices each comprise a collision element and a detector device. The collision element is a component that is arranged in such a way that, when the washing portal moves, it is the first to come into contact with a collision body, for example a person. For example, these can be vertical or approximately vertical rods that extend along the monitoring area on the washing portal.

The collision elements are designed to meet two essential requirements: On the one hand, they should cause as little damage as possible to the collision body in the event of a collision, in particular no scratches to the vehicle or injuries to a person. On the other hand, they must be sufficiently stable and rigid to transmit the force of a collision as directly and without delay as possible. This prevents the collision elements from initially deforming elastically before the force is transmitted to the detector device.

The detector device is a structure or component that is operatively connected to the respective collision element or other parts of the safety device that move in response to a collision and, in particular, is firmly or rigidly connected to the washing portal. In the event of a collision and the associated force acting, for example, on the first and/or second collision element, the latter is designed to yield to this force and allow movement of the collision element, which is detected by the detector device.

In particular, the collision element can be moved by its suspension in such a way that it can avoid a collision body. Movement of the collision element in the direction of the (remaining) washing portal, in particular in the direction of the respective support of the portal or portal column, is expressly permitted and desired.

This movement allows the collision element to evade the collision body after the collision has been detected during the initiated braking process until the washing portal comes to a standstill. This helps to prevent possible damage or injury.

The respective detector device is designed in such a way that it detects the collision event at the very beginning of a force acting on the corresponding collision element and/or coupling element and thus at the beginning of the movement of the collision element in the direction of the respective support of the portal.

For this purpose, the detector device is equipped with suitable sensor technology that registers the effects of the mechanical force on the collision element. In the context of this disclosure, “force” is essentially understood to mean the force caused by the collision of the safety device with a collision body.

In the context of this disclosure, a “collision event” is understood to mean a collision between the safety device and a collision body (in particular a person). A collision between the collision body and the washing portal can be avoided by detecting the collision with the safety device and a subsequent deceleration (triggering of the stopping process) of the washing portal by a control device.

As soon as a collision with the safety device is detected, the collision event can be signaled by means of a suitable signal. In the event of a direct or indirect force acting on the respective collision element or on another component of the safety device and the resulting movement of the safety device relative to the respective detector device, the sensor system can detect the mechanical collision event and optionally make it available for further processing, forward it to control devices (in particular control devices of the washing portal) and/or output it (e.g., on a user interface). Appropriate data connections are provided for this purpose (e.g., fieldbus systems such as CAN bus, Ethernet-based systems, or FlexRay, etc.).

In principle, any suitable sensor technology that reliably detects such movement of the collision element can be used. The movement may be, in particular, a lateral movement in a horizontal plane or a rotational movement in a horizontal plane. The suitable sensor technology for detecting this movement may be designed in particular by means of magnetic or induction sensors and/or optical sensors or the like.

Due to the demanding environmental conditions in a rollover car wash—in particular moisture, dirt, and washing fluids—optical systems may be less suitable as they can be impaired by contamination. Instead, electrical sensors are preferred, for example, induction switches or similar switching elements, which are robust against environmental influences and enable reliable detection of movement.

The collision elements described above are primarily designed to detect a collision at a specific position. In the case of vertical rods, they enable detection along a linear vertical range in particular.

In order to extend the detection range, the present invention provides at least one coupling element. This connects the two collision elements mechanically to each other and, in the case of vertically extending collision elements, preferably extends horizontally between them and optionally extends laterally beyond the second collision element. In the latter case, the coupling element protrudes laterally outwards in an outer area of the washing portal.

The at least one coupling element is coupled to the collision elements in such a way that it still allows independent movement of the collision elements for individual collision detection. At the same time, the application of force, in particular due to a collision of a collision body with the coupling element, leads to at least partial transmission of the force to at least one of the collision elements. This allows the respective detector device to be activated and a collision to be detected.

In one possible embodiment, the mechanical coupling between the first collision element and the at least one coupling element, as well as between the second collision element and the at least one coupling element, is designed in such a way that the two collision elements can move independently of each other.

This means that a force acting on one of the collision elements does not necessarily lead to a movement of the other collision element. Each collision element can move independently and/or separately from the other collision element and/or relative to the washing portal, so that collision detection also works reliably if a collision occurs only on one of the collision elements or in an area of the collision element, for example on another component of the safety device.

Despite this independent mobility, the coupling element remains connected to the collision elements in such a way that a force acting on the coupling element itself can still be transmitted to at least one of the collision elements. This ensures that a collision with the coupling element is also detected. This enables flexible collision detection, as both local collisions at the collision elements and a force acting on the coupling element are detected without restricting the freedom of movement of the individual collision elements.

The couplings of the coupling element with the collision elements are designed in such a way that a force on the coupling element, triggered by a collision, cannot cause a collision element to be blocked in its movements or, for example, to jam.

In a front view, three areas in front of the washing portal and/or in front of the safety device can be defined as follows:
Inner area: This area extends from the first collision element—including it—inward toward the vehicle when viewed from the front. The inner area is part of a space that extends inward toward the vehicle, including the first collision element.
Intermediate area: This area is located between the first and second collision elements, excluding these, when viewed from the front. It begins immediately after the first collision element and ends immediately before the second collision element, without including these.
Outer area: This area extends from the second collision element—including it—in a front view seen outward (towards the side of the washing portal facing away from the vehicle). The outer area is part of a space that extends outward, including the second collision element.

Based on these areas, collision scenarios or the effects of an external force exerted by a collision body on the first or second collision element and on the coupling element can now be described, which can occur individually or cumulatively.

If a collision body exerts a force in the inner area on the first collision element (with a vectorial force component parallel and/or perpendicular to the respective (here: first) slider element in the direction of travel of the portal, running in a horizontal plane), this force is essentially transmitted exclusively to the first collision element and detected by the first detector device.

If a collision body exerts a force in the inner area on the coupling element (with a vector force component parallel to the respective slider element or in the direction of travel of the portal, running in a horizontal plane), this force is transmitted exclusively to the first collision element and detected by the first detector device.

If a force acts on the coupling element within the intermediate area, this force is transferred proportionally to the first and/or second collision element. The term “proportionally” refers to the position of the force acting on the coupling element, proportional to the length of the same. The exact distribution of the force transmission depends on the point of application of the force in the intermediate area. If the point of application is closer to the first collision element, a larger proportion of the force is transmitted to it, while the remaining proportion acts on the second collision element. Conversely, if the force acts closer to the second collision element, a larger proportion of the force transmission is transferred to the second collision element. If the force acts exactly in the middle between the two collision elements- or in the middle of the coupling element, if it protrudes equally over the first and second collision elements-the force is distributed evenly, i.e., half to the first and half to the second collision element.

The movements of the collision elements caused by the collision forces and their distribution between the collision elements result from the reset forces of the respective collision elements, which do not have to be equal. The movement of the coupling rod is detected by the first and/or second detector device, depending on whether the first and/or second collision device is moving.

If a collision body acts with a force in the outer area on the coupling element in an area surrounding the second collision element (with a vectorial force component parallel to the respective (here: second) slider element, or in the direction of travel of the portal, running in a horizontal plane), this force is transmitted almost exclusively to the second collision element and detected by the second detector device.

If a collision body exerts a force in the outer area on the second collision element (with a vectorial force component parallel to the respective (here: second) slider element, or in the direction of travel of the portal, running in a horizontal plane), this force is essentially transmitted exclusively to the second collision element and detected by the second detector device.

If a collision body exerts a force in the outer area on the coupling element (with a vector force component parallel to the respective slider element in the direction of travel of the portal, running in a horizontal plane), the force component with a vector force component parallel to the slider element is transmitted exclusively to the second collision element and detected by the second detector device.

If a collision body exerts a force in the outer area on the coupling element (with a vector force component perpendicular to the respective slider element, or transverse to the direction of travel of the portal, running in a horizontal plane), this force component is transferred to the first collision element. In this case, the force is not detected by either the first or the second detector device.

If a collision body exerts a force within the outer area on the second collision element (with a vector force component perpendicular to the respective slider element in the direction of travel of the portal, running in a horizontal plane), this force causes the second collision detection device to deflect inwards. This collision scenario can be triggered, for example, by a person holding onto the second collision element (combined with inward pressure or a force perpendicular to the direction of travel of the portal). In this case, the force is detected by the second detector device.

If a collision body acts on the second collision element with a force in the outer area (with a vectorial force component parallel and perpendicular to the respective slider element, running in a horizontal plane), the force component perpendicular to the slider element is transferred to the first collision element. The force component parallel to the slider element is detected by the second detector device. This collision scenario can be triggered, for example, by a person holding onto the second collision element (combined with an oblique inward pressure or a force with force components parallel and perpendicular to the direction of travel of the portal).

If a collision body acts on the coupling element with a force in the outer area, in particular on the protruding part of the coupling element (with a vectorial force component parallel and perpendicular to the respective slider element, running in a horizontal plane), the force component perpendicular to the slider element is transferred to the first collision element. The force component parallel to the slider element is transferred to the second collision element and detected by the second detector device.

With the help of the first and/or second detector device and the independent movement possibilities of the collision elements, it is possible to detect whether a collision is taking place in a first area, namely in the inner area or in the intermediate area in the immediate vicinity of the first collision element, or in a second area, namely in the outer area or in the intermediate area in the immediate vicinity of the second collision element. In the first collision case (first area), essentially only the sensor of the first detector device will be triggered, and in the second collision case (second area), essentially only the sensor of the second detector device will be triggered. If both sensors of the first and second detector devices are triggered simultaneously, it can be concluded that the collision is essentially taking place in an area between the first and second collision elements or that several collision bodies are colliding simultaneously.

The sensor signals (triggers) can be fed to a processing unit in order to trigger corresponding control signals, in particular for the washing portal.

In one possible embodiment, the at least one coupling element is rotatably coupled to the first collision element, in particular substantially horizontally rotatable. In particular, the at least one coupling element may be rotatable about a vertical axis. Rotatable preferably refers to a horizontal plane, for example about a collision element or a part thereof.

Alternatively or additionally, the at least one coupling element may be slidably coupled to the second collision element, in particular slidable and/or rotatable substantially horizontally. This slidable coupling between the coupling element and the second collision element may also expressly allow the coupling element to twist on or around the second collision element.

The rotatable coupling on the first collision element not only allows the collision element to move toward the support of the washing portal, but also allows it to move sideways (evasion manoeuvre). This can be particularly advantageous if the collision element comes into contact with a protruding part of the vehicle, such as an exterior mirror. The rotatability allows the collision element to yield to such lateral forces and adapt flexibly to the collision body, thereby reducing the risk of damage.

The sliding coupling on the second collision element, on the other hand, ensures that this collision element moves little or not at all sideways due to the design of the guide of the associated slider element (also known as a carriage) on the detector device. Furthermore, the sliding coupling prevents lateral movements and lateral forces of the coupling element from being transferred to the second collision element, so that this does not lead to any unwanted deflection (in the following, deflection is understood to mean rotational deflection as opposed to lateral displacement) of the second collision element. This ensures precise detection of the collision while at the same time enabling independent mechanical coupling between the elements.

In a first embodiment of the second detector device, the second slider element cannot perform any significant (rotational) deflection (“no significant” swivel movement here refers in particular to a swivel movement with a lower maximum rotational deflection than the swivel movement of the first slider element). In particular, in the first embodiment, two bearing elements may be provided for guiding the second slider element in the second guide (also guide device).

In a second embodiment of the second detector device, however, the second slider element can perform a deflection, just like the first slider element of the first detector device. In the second embodiment of the second detector device, the second collision element can move sideways in addition to the linear movement against the direction of movement of the portal (in a horizontal plane). This movement of the second collision element is compensated for by the displaceable and rotatable coupling to the coupling element without this having any effect on the first collision element. In particular, in the second embodiment, only one bearing element may be provided for guiding the second slider element in the second guide (also guide device).

The combination of the first embodiment of the second detector device consisting of a rotatable coupling on the first collision element and a displaceable coupling on the second collision element ensures adaptation to different force effects. This ensures that both at least partially independent movement of the collision elements and reliable collision detection are possible, which is also the case with the second embodiment of the second detector device.

In one possible embodiment, the at least one coupling element is coupled to the first collision element on an inner side. The inner side is the side of the safety device that faces the object (vehicle) to be cleaned and on which the first collision detection device is provided.

On the inner side, the coupling element can be essentially flush with the first collision element. This means that the coupling element is connected to the first collision element in such a way that it has no or only minimal protrusion on the side facing the object to be cleaned. Alternatively, the coupling element may have a protrusion that is adapted in particular to the lateral extension of internal washing units of the washing portal (e.g., wheel rim washers).

A completely flush connection can be achieved, for example, by integrating the coupling element completely or as far as possible into a corresponding recess or indentation in the first collision element. If there is only a slight indentation or if such embedding is not possible, for example for stability reasons, there may be a slight protrusion. This should be kept as small as possible and can typically be in the range of a few millimeters. Preferably, this range is between 2 mm and 5 mm, more preferably between 2 mm and 3 mm.

In one possible embodiment, the at least one coupling element is coupled to the second collision element on an outer side. The outer side is the side of the safety device opposite the inner side and on which the second collision detection device is provided.

On this outer side, the coupling element can protrude beyond the second collision element and/or beyond a lateral outer side of the washing portal as seen in the front view by a predetermined amount. This allows the monitoring area to be extended towards the outer side. Since there is no vehicle to be cleaned on this side, no special consideration needs to be given to vehicle contours. This allows for a design in which the coupling element protrudes further outwards in order to reliably detect collisions occurring there as well, e.g., when a person is standing outside next to the washing portal.

This arrangement is particularly advantageous for person protection. Since people may potentially be present in this area, the protruding coupling element extends the monitored space and helps to detect collisions comprehensively and at an early stage.

In addition, the protrusion of the coupling element ensures that units or other components protruding sideways beyond the washing portal are also included in the detection range of the safety device. Examples of such components are splash guards, technical housings, or other attachments located in front of the washing portal and protruding beyond the actual boundary of the washing portal. By covering these areas, the coupling element ensures that all potential collision surfaces are detected.

The coupling element can be arranged asymmetrically and protrude to varying degrees inwards (beyond the first collision element) and outwards (beyond the second collision element). This enables even better adaptation to components and/or washing units of the washing system.

In one possible embodiment, the safety device comprises at least two coupling elements.

The use of multiple coupling elements makes it possible to specifically expand the monitoring area. In the case of vertically extending collision elements, the coupling elements are preferably aligned horizontally so that they can be arranged at different heights. This allows collisions to be detected across the entire width of the monitored area at different heights.

The individual coupling elements are preferably mechanically decoupled from each other, i.e., there is no fixed or rigid connection between them. This decoupling ensures that each coupling element can react independently to a collision without necessarily causing movement or force transmission to another coupling element.

In a simple design, for example, two coupling elements can be provided to detect collisions at two different heights. However, depending on the application and the desired monitoring area, more than two coupling elements are also possible in order to cover an even larger area. For example, the height of the coupling elements is based on the height of standing adults and the height of standing children.

In one possible embodiment, the first collision detection device comprises a first suspension device arranged above the first collision element. This suspension device is designed to hold the first collision element so that it hangs vertically and can perform a horizontal pendulum movement relative to the first suspension device. The pendulum motion may in particular be a pendulum motion in approximately a horizontal plane (“approximately” here means that the vertical motion is negligible in relation to the horizontal motion).

Alternatively or additionally, the second collision detection device may similarly comprise a second suspension device arranged above the second collision element. This is also designed so that the second collision element hangs vertically and can perform a horizontal pendulum movement relative to the second suspension device. The pendulum movement may in particular be a pendulum movement in approximately a horizontal plane (“approximately” here also means that the vertical movement is negligible in relation to the horizontal movement).

These suspension devices allow the collision elements to yield and deflect when force is applied. One possible embodiment comprises a rod that is movably attached to the respective suspension device so that it can swing freely downward.

The suspension devices themselves are arranged at a fixed distance from the support of the washing portal towards the front. This distance is usually fixed or constant and dimensioned so that the collision element can still perform a sufficiently large pendulum movement after a collision. This ensures that the washing portal is brought to a standstill in good time after collision detection before the maximum deflection of the pendulum movement is reached.

In one possible embodiment, the first slider element is rigidly connected to the first collision element and coupled to the first detector device via a guide. The guide in which the first slider element is guided can be the guide device of the first detector device. The slider element is designed such that, when a force is applied to the first collision element, it performs a linear movement in the opposite direction to the movement of the washing portal. Alternatively or additionally, it can be designed to perform a pivoting movement when a lateral force with a vectorial component, in particular a horizontal component, is applied perpendicular to the direction of movement of the washing portal. This pivoting movement takes place in particular in the direction of the outside of the washing portal, i.e., away from the object to be cleaned.

The second detector device is coupled to a second slider element, which is rigidly connected to the second collision element and coupled to the second detector device via a guide. The guide in which the second slider element is guided can be the guide device of the second detector device. This slider element is also designed to perform a linear movement against the direction of movement of the washing portal when a force is applied against the direction of movement.

The second collision detection device, in particular the second detector device, can be designed in two different versions. In a first version of the second collision detection device, the second slider element is guided and/or supported in the second guide device via two second bearing elements. In a second version of the second collision detection device, in particular the second detector device, the second slider element is guided and/or supported in the second guide device via only one second bearing element.

In the first embodiment of the second collision detection device (in particular the second detector device) with two bearing elements, in particular pins, the second slider element does not perform any significant pivoting (or rotating) movement when a lateral force is applied. “No significant” pivoting movement here also means, in particular, a pivoting movement with a smaller maximum deflection than the pivoting movement of the first slider element.

In the second embodiment of the second collision detection device (in particular the second detector device) with only one bearing element, in particular a pin, the second slider element performs a pivoting movement when a lateral force is applied in the direction of the vehicle to be cleaned. In this version, the second collision detection device behaves like the first collision detection device, only mirrored about the central plane lying between them. In this second version, it can have a corresponding structure to the first collision detection device.

The bearing element of the second and/or first collision detection device can be designed as a pin in particular.

The bearing element of the second collision detection device can be designed as a single element (e.g., a pin) or two elements (two pins). The diameter of the second pin of the second collision detection device is preferably between 50% and 95% of the diameter of the first pin. In the side view, the second pin can be arranged behind the first pin in the direction of movement of the portal.

The first slider element allows both linear rearward movement and lateral swivel movement in the direction of the second collision detection device. This allows the first collision element to yield to a lateral force, for example when it collides with a protruding vehicle part such as an exterior mirror. In one embodiment, however, the suspension of the second slider element is designed in such a way that only a small amount of lateral movement is possible. This small lateral movement is expressly provided in order to be able to detect a lateral force acting on the second collision element in the direction of the vehicle to be cleaned without this leading to a significant swivel movement.

In one possible embodiment, the maximum distance of linear movement of the first and/or second slider element when a force with a vector component opposite to the direction of movement of the washing portal is applied is greater than the braking distance of the washing portal.

This means that the slider elements are designed to allow sufficient movement of the collision elements during a collision. After a collision is detected, the washing portal is brought to a halt, whereby the portal does not come to a complete stop immediately due to its mass and inertia, but only after a certain distance (overrun distance). In order to allow the collision elements to continue moving during this braking process, the available distance of the slider elements must be greater than the braking distance of the washing portal.

This arrangement ensures that the collision element can continue to move out of the way during the stopping process (braking process) and that a collision between the washing portal itself, in particular the rigid supports (portal columns), and the collision body is avoided. This contributes significantly to preventing major damage to the collision body or injury to persons. In one possible embodiment, the first detector device comprises a first reset device. This holds the first slider element in a starting position with a predetermined force as long as no external force acts on the slider element.

Accordingly, the second detector device comprises a second reset device. This holds the second slider element in an initial position with a predetermined force until an external force is applied.

The reset devices ensure that the slider elements and thus the entire safety device are kept in a defined state before a possible collision. This ensures that the collision elements assume their intended position. Only when an actual force is applied can they evade.

The forces of the reset devices should be selected so that they meet several essential requirements. On the one hand, they must reliably hold the slide elements in the initial position as long as the washing portal is in operation. On the other hand, they must not be so high that they prevent the slider elements from moving in the event of a collision, and they must not increase significantly over the long follow-up path. Rather, the design should be such that the collision element can easily give way at the point of collision. This prevents damage or injury.

Various mechanisms can be used for the reset devices. These include springs or elastomers. However, weight systems in combination with cable pulls or similar mechanisms are particularly advantageous. These enable an approximately uniform reset force over the entire movement path of the slider element. As a result, the force acting on the slider element—and thus on the collision element—does not increase further during movement. This ensures a uniform and controlled response to a collision.

In one possible embodiment, the first slider element is guided in a first guide device (also simply referred to as a guide) and/or mounted via a first bearing element. This guide device comprises a first elongated hole or a comparable first opening. Within this guide, the first slider element is supported via a first bearing element, in particular a first pin. This allows the slider element to perform both a longitudinal movement along the guide device and a pivoting movement around the bearing element.

The first guide device serves as a defined movement path for the slider element. Inside this opening is the bearing element, preferably in the form of a pin, which guides the movement of the slider element. Due to this arrangement, the slider element can move linearly within the first guide device while at the same time remaining capable of rotating around the bearing element.

The respective bearing element is designed in such a way that it has only a small amount of play within the guide device, particularly in the defined state of the collision element, the zero position (position without external force acting on the safety device). The tolerance is selected so that jamming or tilting of the slider element is avoided. The play of the guide device is greater when the collision element is no longer in the zero position in order to prevent the slider element from jamming in the guide device.

This design ensures that the first slider element can perform a controlled linear movement and also allows a swiveling movement when lateral force is applied.

In a possible (first) embodiment, the second slider element is guided in a second guide device (also referred to simply as a guide) and/or supported by at least one second bearing element. This guide device comprises a second elongated hole or a comparable second opening. The second slider element can be supported in the second guide device via one or two second bearing elements, in particular one or two second pins. In other words, the at least one second bearing element of the second detector device can have one or two pins. The pins can have different diameters, as explained below.

The arrangement of two pins greatly restricts and essentially prevents the swivel movement of the second slider element. The two pins are arranged offset within the guide device. This design of the second detector device in its first embodiment with two bearing elements ensures that the second slider element can move predominantly in a linear motion along the guide device. “Primarily” here means that the main movement is linear, but a slight swiveling movement is also possible, especially around the first pin.

The second guide device should be sufficiently large to allow the required travel of the second slider element. This is particularly important in view of the fact that both pins must be moved within the guide.

The term “essentially” refers to the fact that lateral movement of the second slider element is severely restricted but not completely excluded. The remaining lateral movement results from the play between the pins and the width of the elongated hole in the guide device. This movement is intentional and serves to allow minimal lateral displacement when lateral force is applied in order to detect this force.

Typically, the lateral mobility is in the range of 1 mm, 2 mm, or up to 5 mm.

In one possible embodiment, at least one of the two pins has a reduced diameter compared to the second guide device. This allows limited lateral relative movement of the second slider element within the guide device.

Preferably, the thinner pin is the front pin when viewed in the direction of movement from the rest position, or the rear pin when viewed in the direction of movement of the washing portal. In other words, it is preferably the pin that is further away from the second collision element, and which is hereinafter referred to as the first pin. While this first pin has a certain amount of additional play within the guide device, the second pin should be guided in such a way that stable positioning of the second slider element in its zero position is ensured. This play increases when the second collision element moves out of its zero position.

A certain tolerance is also provided for this second pin. This should be dimensioned so that friction-free movement along the intended path is possible without jamming or sticking. The first pin with the reduced diameter allows limited lateral movement of the slider element. This movement is selected so that it makes a lateral force acting on the second collision element in the direction of the vehicle to be cleaned detectable without allowing uncontrolled swiveling.

The second elongated hole preferably has a shape which runs essentially straight on one long side and causes a taper in the gap width on the opposite long side. The taper in the gap width is preferably formed in the immediate vicinity of the second pin.

The aforementioned reset device holds the second slider element in its rest position, even if one of the pins has greater play within the guide. Movement from this rest position only occurs when a corresponding force is applied to the slider element, thereby ensuring reliable collision detection.

In one possible embodiment, the first pin can be very small relative to the gap width of the second elongated hole.

Alternatively, in a (second) embodiment, it is possible for the second slider element to be guided and/or supported in the second guide device only via a second bearing element, in particular a second pin, so that one of the two bearing elements, in particular the first pin, is omitted entirely. In the second embodiment of the second collision detection device, the bearing for the second slider element in the second guide device corresponds to the bearing for the first slider element in the first guide device and is essentially only mirrored about the intermediate center plane. In other words, in this embodiment, the second guide device of the second detector device is in operative connection with only one bearing element, in particular a pin. The second slider element can therefore perform both a lateral displacement and a rotation inwards (towards the vehicle to be washed).

In one possible embodiment, the first collision element has a contoured shape that at least partially reflects the maximum treatment space for the object to be cleaned. In particular, the collision element may have an adapted geometry in areas with lateral assemblies or other components of the rollover car wash.

While a simple, straight rod is conceivable as a collision element, an adapted shape may prove advantageous due to the more complex vehicle geometry and the various machine elements of the washing system. This applies, for example, to protruding vehicle parts such as exterior mirrors, but also to special washing units of the rollover car wash that protrude further into the cleaning area.

The specific design of the first collision element ensures that it adapts to the actual conditions. For example, the collision element in the area of a wheel washer can protrude further into the cleaning area to ensure effective monitoring of this area.

This adaptation ensures that the safety device optimally covers the maximum treatment space for the vehicle while ensuring reliable collision detection.

In one possible embodiment, the at least one coupling element has a lateral extension toward the outside. Viewed from above, this extension extends laterally beyond the vertical projection of a support of the washing portal. This allows, in particular, laterally protruding assemblies or other components of the washing portal to be covered.

While the second collision element typically monitors the outer edge of the portal column of the washing portal, there may also be other components or assemblies that protrude beyond this boundary toward the outside. A example of this is a splash guard for a washing brush that protrudes beyond the actual support of the portal.

By using coupling elements that protrude to the side, especially if they run at least approximately horizontally, the monitoring area can be specifically shielded in the direction of travel. These coupling elements extend so far into the outside area that protruding components or assemblies of the washing portal are also detected.

This ensures that a possible collision of these protruding components can be detected and prevented in advance and that a person is prevented from actively walking around the coupling rods in the outside area. In this way, not only is the washing portal itself protected, but safety in the vicinity of the rollover car wash is also improved.

In one possible embodiment, the first collision detection device comprises a first sensor element that is designed to detect movement of the first collision element. Accordingly, the second collision detection device comprises a second sensor element that can detect movement of the second collision element.

The sensor elements may comprise several components and/or are to be understood as sensors that output a sensor signal as soon as a collision event occurs between the safety device and a collision body. Since a collision causes movement within the first and/or second collision detection device of the safety device, these movements can be reliably detected by the sensor elements. The movements can be lateral movements and rotational movements. The sensor elements can in particular comprise a sensor signal transmitter and a sensor signal receiver, which are arranged on components of the respective collision detection device that are movable relative to each other, in particular to detect the movement (lateral displacement or rotation) of the slider element (also referred to as a slider). The sensor signal transmitter can preferably be arranged on a movable component of the collision detection device (such as the slider element). The sensor signal receiver can preferably be positioned on a unit that does not belong to the collision detection device, such as a side surface of the washing portal in the immediate vicinity of the slider element.

It is particularly advantageous to arrange the sensor elements on or within the respective detector devices. In this way, for example, movements of the slider elements can be detected directly, as these are triggered by a force acting on the respective collision element.

In principle, various types of sensors can be used, provided they are capable of detecting a change from the rest position. While optical systems such as fork light barriers would in principle be suitable, their use in the harsh environment of a vehicle washing system can be problematic due to dirt and moisture. Therefore, electrical systems, in particular inductive sensors or comparable sensors, are preferable. These enable reliable detection of movement under the demanding conditions of a vehicle washing system.

In one possible embodiment, the safety device interacts with a control device that is designed to stop the movement of the washing portal if at least one sensor signal is detected, for example, when the first collision element or the second collision element is detected moving. The control device also triggers a stop of the washing portal movement if both detection devices, in particular both sensors, trigger a signal, e.g., if movement of the first collision element and the second collision element is detected.

Data is exchanged between the safety device and the control device via appropriate networks (e.g., bus system) or data connections (wired or wireless, such as radio connections). The control device can also be integrated into the safety device as a component. In this case, internal interfaces are used.

This control device ensures that, after a collision with the safety system is detected, a process is initiated that stops the washing portal as quickly as possible in order to prevent a collision between the washing portal and the collision object and thus avoid damage or injury.

The control device can be integrated into a higher-level control unit that manages the entire washing process or the operation of the washing portal. Alternatively, it can also be designed as a separate, dedicated control unit that operates independently of the main control system and is specifically responsible for safety aspects. The latter has the advantage that even in the event of a malfunction of the main control system, the safety device can still ensure that the washing portal is shut down safely.

The control concept can be implemented in various ways. One option is software-based implementation, in which the control logic is executed as program code. This program code can be stored in a memory and processed by a microcontroller or a comparable computing unit.

Alternatively, hardware-based solutions are also possible, for example in the form of electrical or electronic circuits. These can be based on discrete electronic components that cause the washing portal to shut down directly in the event of a collision.

In one possible embodiment, the washing portal comprises at least one protective element between the two collision elements and/or the coupling elements. In particular, the protective element can be arranged in an intermediate area between the coupling elements and between the two collision elements. The protective element serves to protect components of the washing portal that are located further back in the direction of movement. This protective element can be designed as a rod construction and/or as a flat construction, e.g., as a flexible plate or fabric (textile, cloth, or flexible material), and extends at least partially between these components.

The protective element serves to create a mechanical barrier between the safety device and components or attachments of the washing portal located further back. This prevents objects or persons from accidentally entering this space during operation.

In one possible embodiment, the protective element can be designed as a continuous or segmented bar extending across the relevant area. Alternatively or cumulatively, panels or flexible tarpaulins or grid structures are possible, which offer even greater coverage. The choice of the specific protective element may vary depending on the structural conditions of the washing portal and the required safety requirements.

This measure ensures that there are no unprotected gaps between the safety device and the subsequent components of the car washing portal, thereby further increasing safety for people and objects in the vicinity of the car wash.

The present invention therefore relates to a safety device for a rollover car wash, which is configured to detect collisions between the safety device and objects, collision bodies, or persons at an early stage in order to prevent collisions between the collision body and the washing portal and to stop the movement of the washing portal in the event of a collision. For this purpose, the safety device comprises a first and a second collision detection device, each of which includes a collision element and an associated detector device.

A central feature of the invention is the use of at least one coupling element that mechanically connects the two collision elements to each other, thereby extending the detection range for a collision. The at least one coupling element, in particular two, are designed in such a way that they allow independent movement of the collision elements so that they can continue to react to local forces. At the same time, the coupling elements ensure that a collision with a coupling element causes a force to be transmitted to at least one of the collision elements and the associated detector device, thereby ensuring reliable detection of the collision event.

To further optimize the safety device, adapted collision elements, protruding coupling elements, and/or protective elements may be provided to cover different areas of the rollover car wash. A control device ensures that the washing portal is stopped as quickly as possible after the collision is detected in advance. This design effectively and reliably prevents collisions with the rollover car wash, thereby significantly increasing safety in the rollover car wash.

Within the scope of this invention, there are components or elements that occur in a first or second instance (e.g., first collision element/detector device/slider element . . . and second collision element/detector device/slider element . . . ). If the respective component is mentioned or described without the adjective “first” or “second,” the statement shall apply to both instances.

### BRIEF DESCRIPTION OF THE FIGURES

To further illustrate the invention, various features and modes of operation of the safety device are explained in more detail below using examples of embodiments. Reference is made to the accompanying figures, which show exemplary representations of the invention. The figures serve to illustrate the concept of the invention and clarify possible design implementations of the described safety device for a rollover car wash.

They show:

FIG. 1 shows a schematic top view of a rollover car wash with a movable washing portal.

FIG. 2a shows a schematic representation in a front view of a part of the washing portal with a safety device according to one embodiment.

FIG. 2b shows a schematic representation of the washing portal shown in FIG. 2a in a side view with a safety device according to one embodiment.

FIG. 3a shows a schematic representation of the first collision detection device with a first detector device in a top view.

FIG. 3b shows a schematic representation of the first detector device with the first bearing element in a top view.

FIG. 3c shows a schematic side view of the first detector device and the first reset device, which is connected to the first slider element and the first collision element.

FIG. 4a shows a schematic representation of the second collision detection device with a second detector device with two second bearing elements in top view.

FIG. 4b shows a detailed representation of the second detector device in plan view.

FIG. 4c shows a schematic side view of the second detector device and the second reset device associated with the second slider element and the second collision element.

FIG. 5 shows a schematic representation of a coupling element according to one embodiment.

FIG. 6 shows a schematic representation of a collision scenario in the event of a frontal collision with the first collision element.

FIG. 7 shows a schematic representation of a collision scenario in the event of a side collision with the first collision element.

FIG. 8a shows a schematic representation of a collision scenario in the event of a side collision with the second collision element according to a first embodiment.

FIG. 8b shows a schematic representation of a collision scenario in the event of a side collision with the second collision element according to a second embodiment.

FIG. 8c shows a schematic representation of a collision scenario in the event of a side collision with the second collision element according to a second embodiment.

FIG. 9 shows a schematic representation of a collision scenario in the event of a collision with a coupling element in a central area between the collision elements.

FIG. 10 shows a schematic representation of a collision scenario involving a collision with a coupling element near the first collision element.

FIG. 11a shows a schematic representation of a collision scenario in the event of a collision with a coupling element in the intermediate area near the second collision element.

FIG. 11b shows a schematic representation of a collision scenario in the event of a collision with a coupling element in the outer area near the second collision element.

FIG. 12a shows a schematic representation of a collision scenario in the event of a collision with a lateral force acting on a coupling element between the second collision element and the outer end.

FIG. 12b shows a schematic representation of a collision scenario in the event of a collision with a lateral force acting on a coupling element between the second collision element and the outer end.

FIG. 13 shows a schematic top view of a column of the washing portal with the safety device according to one embodiment.

FIG. 14 shows a block diagram of a control device for controlling the washing portal based on signals from the collision detection devices.

Various embodiments of the invention are explained in more detail below with reference to the figures shown. The examples shown in the figures are for illustrative purposes only and are not to be understood as limiting. Individual features of the described embodiments can be combined with each other or implemented in modified form, provided that this is technically possible and there are no conflicting requirements. In the figures, identical or similar elements are assigned the same reference symbols.

### DESCRIPTION OF EMBODIMENTS

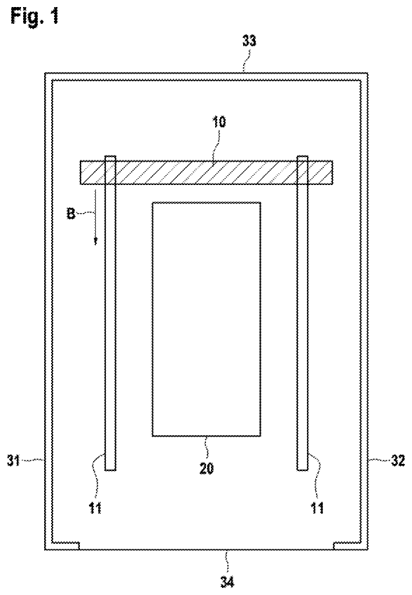

FIG. 1 shows a schematic representation of a top view of a rollover car wash according to one embodiment. This rollover car wash can be located, for example, in a room or hall bounded by two side walls 31 and 32, an end wall 33, and an entrance with an opening 34. The opening 34 can, for example, be designed as a gate or similar access device and allows a vehicle 20 to drive into the working area and be parked at a predefined position.

After driving in, the driver should leave the vehicle 20 and the working area and start the washing process from outside.

During the washing process, the washing portal 10 can move along guide rails 11, for example in direction of movement B. Various washing and cleaning processes can be carried out. For example, the vehicle 20 can be wetted with washing liquids or treated with brushes or other cleaning devices.

In addition, special washing brushes, e.g., for wheel cleaning (e.g., rim washers), may be provided, which can be extended at the positions of the wheels in the direction of the vehicle 20 in order to improve the cleaning effect. Likewise, additional units, such as blowers or other drying devices, may be provided to dry the vehicle 20 after cleaning.

The processes mentioned for cleaning the vehicle 20 are examples and are not to be understood as restrictive. Depending on the design of the rollover car wash, additional or alternative washing and care processes may be provided.

Comparatively large forces are required to move the washing portal 10. This is due, on the one hand, to the high mass of the washing portal 10, which must be accelerated and decelerated. On the other hand, significant resistance is generated during operation, for example due to the friction of the washing brushes on the surface of the vehicle 20 and due to further mechanical loads on the cleaning units. To counteract these resistances, powerful drives are required that enable controlled movement of the washing portal 10.

However, due to this high mass and the required drive forces, there is a considerable risk of collision between the washing portal 10 and a collision body or obstacle. Such a collision can cause considerable damage to objects. Even more critical is the risk to persons who may be in the working area during the washing process, as a collision with the washing portal 10 can result in serious injury.

In addition to collision with vehicle parts or other objects, there is also a risk that unwanted objects may be in the working area of the washing portal 10 when the washing process is started. It is also possible that a person may still be in the working area when the washing process is initiated. In some cases, a person may enter the working area after the washing process has started. This could be the case, for example, if the user returns to their vehicle 20 to close an open window or to remove items from the vehicle.

It is therefore crucial that collisions with the washing portal 10 are avoided and that such collision situations are detected at an early stage so that the movement of the washing portal 10 can be stopped as quickly as possible in the event of a collision.

The following describes a concept for a possible safety device designed to detect a collision hazard, in particular to detect possible collisions in advance and thus as early as possible. This early detection allows the movement of the washing portal 10 to be stopped as quickly as possible as soon as a collision of the safety device with a collision body (object or person) is detected in order to avoid a collision of the washing portal with the collision body.

The safety device described not only prevents collisions with the vehicle 20, in particular with protruding attachments such as a side mirror, but is also specifically designed to detect other collision objects (e.g., persons). This includes, in particular, objects or persons that are outside the direct washing area of vehicle 20 but are within the sphere of influence of the movable washing portal 10.

Such a critical area may be located, for example, directly in front of the washing portal columns (also: supports of the washing portal 10), where a person could be standing or an object could be placed. Similarly, parts of the washing portal 10 that protrude outwards may be located in the collision area, for example, in the case of protruding components or assemblies. With the appropriate design of the safety device, this extended area can also be reliably monitored in order to detect potential hazards at an early stage.

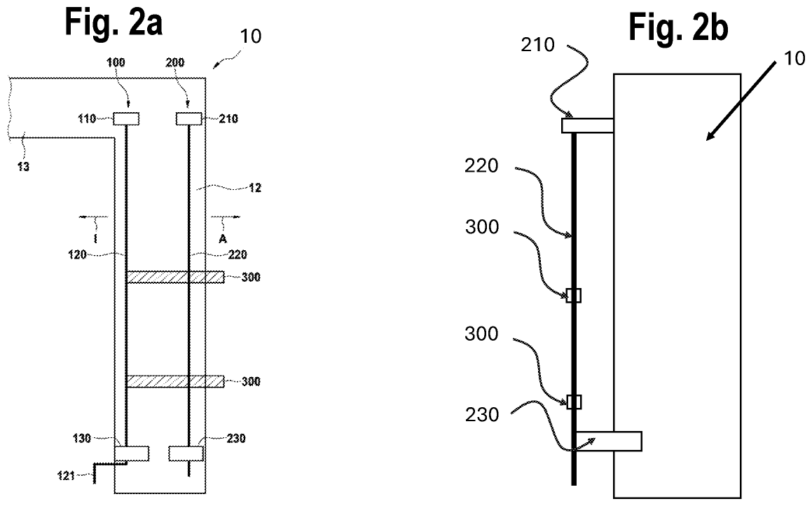

FIG. 2a shows a part of a washing portal 10 in front view. Shown is a section of a crossbeam 13, on which various cleaning components may be provided. These include, for example, a roof brush for cleaning the vehicle roof (not shown).

The cross member 13 is supported by two lateral supports 12 (portal columns), of which only the right support 12 is shown in FIG. 2a. Cleaning components or additional units for vehicle cleaning (such as wheel rim washers, not shown) can also be arranged on this support 12.

To facilitate orientation within the illustration, the side of the support 12 facing the vehicle 20 to be cleaned is marked with I (inside), while the side facing away from the outside of the vehicle is marked with A (outside).

Not shown in FIG. 2a are the cleaning units or additional components such as brushes or covers for splash protection. However, such components may extend not only toward the inside I, but also toward the outside A across the width of the support 12.

FIG. 2a also shows the components of the safety device, which are designed to prevent the washing portal from colliding with an obstacle. Such an obstacle can be an object, a person, or an animal.

The safety device comprises two collision detection devices 100 and 200. The first collision detection device 100 is arranged in the direction of the inside I of the support (also column or portal column) 12, predominantly approximately in line with the inner edge of the support 12, so that it can detect relevant collisions in this area. Such relevant collisions include, for example, collisions with vehicle parts such as a side mirror. If a vehicle part protrudes so far toward the support 12 that it could collide with the units of the washing portal 10 when passing through the washing portal 10, such a collision should be detected in advance by the first collision detection device 100 before contact occurs with the subsequent components of the washing portal 10.

To detect such collisions, the first collision detection device 100 comprises a first collision element 120. This is arranged in such a way that, when the washing portal 10 moves along the direction of movement B, it first comes into contact with a protruding vehicle part before the subsequent components of the washing portal 10 or the inner edge of the column 12 would hit this vehicle part.

The first collision element 120 may have a substantially vertical structure. For example, it may be designed as a rod or consist of several rod sections. In addition, the collision element 120 may have a shape, particularly in the direction of the inner side I, which is adapted to the washing units or components of the respective support 12.

FIG. 2a shows an example of a section 121 in which the first collision element 120 protrudes further into the interior. This can be particularly advantageous if there is a special unit on the support 12 in this area, e.g., for wheel washing, which also protrudes further into the interior. This adaptation ensures that the first collision element 120 also reliably prevents collisions with such protruding components.

The shape of the first collision element 120 shown in FIG. 2a (essentially extending linearly) is merely an example and should not be understood as restrictive. Depending on the specific design of the rollover car wash, the collision element 120 may have a different geometry in order to meet specific requirements, e.g., with a curved shape.

The first collision element 120 can be made of a suitable material that meets the specific requirements of the application. In particular, care must be taken to ensure that the material has sufficient resistance to washing fluids to ensure long-term functionality. At the same time, the collision element 120 should be designed in such a way that it does not cause damage to a collision body or injury to a person in the event of a collision. Nevertheless, the collision element 120 should have sufficient rigidity so that the forces acting on the collision element are transmitted as directly as possible in order to enable reliable detection of the collision event. The first and second collision elements can be made of a composite material, e.g., carbon or metal.

The first collision detection device 100 comprises a first suspension device 110 in the upper region, which is designed such that the first collision element 120 hangs down from it. The first collision element 120 is arranged at a defined distance from the support 12. This distance is chosen so that, in the event of a collision, the first collision element 120 can first perform an evasive movement before the washing portal 10 is brought to a complete standstill.

The first suspension device 110 is designed in particular so that it allows the first collision element 120 attached to it to perform a torsional oscillation or pitching oscillation, whereby this movement takes place in a substantially horizontal plane. This can be achieved, for example, by the first suspension device 110 having an opening in which a fastening component for the first collision element 120 is mounted so that it has sufficient play for the pendulum movement.

The first detector device 130 is operatively connected to the first collision element 120 and is fixedly or rigidly connected to the column 12. This allows the first collision element 120 to perform a relative movement with respect to the first detector device 130 in the event of a collision with a collision body.

The force transmission in the event of a collision between the safety device and a collision body triggers the movement of a first slider element. This movement is detected by the first detector device 130 and serves as an indicator of an imminent collision between the collision body and the washing portal.

The safety device exchanges data with a control unit which, based on this detected collision event, initiates appropriate measures, such as stopping the movement of the washing portal 10.

The second collision detection device 200 is arranged on the support 12 on the front side as seen in the direction of movement B, but in the direction of the outside A.

Similar to the first collision detection device 100, the second collision detection device 200 also comprises a second suspension device 210 on which the second collision element 220 is arranged. This is designed in such a way that it can also perform a torsional oscillation or pitching oscillation, i.e., an essentially horizontal pendulum movement.

The second collision element 220 can essentially be designed as a linear, preferably vertical rod. Similar material requirements apply to the second collision element 220 as to the first collision element 120, in particular with regard to resistance to washing fluids, gentle contact with collision bodies, and sufficient stiffness for force transmission. The safety device, and in particular the two collision elements and the two coupling elements, are made of metal, in particular metal and/or a composite material, e.g. carbon. Alternatively or additionally, the collision elements and the two coupling elements in particular may be coated with a plastic.

Furthermore, the second collision element 220 is in operative connection with the second detector device 230, which is fixedly or rigidly connected to the column 12. This allows a corresponding relative movement between the second slider element and the second detector device 230 in the event of a collision, whereby the collision event can be detected and a suitable response, such as stopping the movement of the washing portal 10, can be initiated.

In order to detect a force acting on the first and/or second collision element and/or coupling element, particularly caused by a collision, the first and/or second detector device 130, 230 may comprise a sensor unit with at least a first and/or second sensor element 136, 236.

Now that the basic features of the first collision detection device 100 and the second collision detection device 200 have been described, the concept of the coupling elements 300 will be explained below.

The first and second collision elements 120, 220 run essentially perpendicular, i.e., vertically. In addition, the safety device comprises one or more coupling elements 300, which serve to extend the detection of collisions to an extended area.

Each coupling element 300 runs horizontally or at least approximately horizontally and is mechanically coupled to both the first collision element 120 and the second collision element 220. However, this mechanical coupling is designed in such a way that the first and second collision elements 120, 220 can continue to move independently of each other in their intended directions of movement. In particular, the pendulum movement of the collision elements remains possible, so that collision detection is guaranteed without restriction. This is made possible by the fact that the coupling of the coupling element to the first and/or second collision element has enough play to allow one collision element to be tilted relative to the other.

The coupling elements 300 are preferably arranged in a region between the respective suspension devices 110, 210 and the respective detector devices 130, 230.

It may be advantageous to arrange the detector devices 130, 230 as far down as possible, since in this position they can detect even minimal deflections of the pendulum movements of the respective collision elements with particular precision. At the same time, however, the detector devices 130, 230 should be arranged sufficiently high up so that they are not affected by liquids or dirt splashing up from below.

In principle, it is also possible to arrange at least one coupling element 300 below the detector devices 130, 230. In such a design, the coupling element 300 can help to detect possible collisions in the lower area between the collision elements 120, 220, so that reliable collision detection is also ensured there.

The mechanical coupling of a coupling element 300 to the first collision element 120, i.e., the collision element arranged toward the inside I, is preferably designed so that the coupling element 300 does not protrude beyond the first collision element 120 toward the vehicle 20, or protrudes as little as possible.

This can be achieved, for example, by providing a suitable recess or cutout in the first collision element 120 for the mechanical connection between the first collision element 120 and the coupling element 300. The coupling element 300 protrudes into this recess or cutout so that, when assembled, it is as flush as possible with the outer contour of the first collision element 120. On the other side, i.e., toward the outer side A or at the second collision element 220, the coupling element 300 may protrude beyond the second collision element 220.

Such protrusion towards the outer side A may be particularly desirable or intentional. This lateral extension of the coupling elements 300 also allows an extended area towards the outside A to be monitored. This allows potential collisions with objects or persons further outside to be detected at an early stage, even if they are outside the direct area of the collision elements 120, 220.

FIG. 2b shows a part of a washing portal 10 in a side view from the outside of the washing portal 10. The side view shows the suspension device 210, to which the second collision element 220 is attached in a freely movable (pendulum) manner. The suspension device 210 is designed in such a way that it can also perform a torsional oscillation or pitching oscillation of the second collision element 220, i.e., a substantially horizontal pendulum movement.

The second detector device 230 is rigidly or fixedly connected to the washing portal 10 or attached to the washing portal.

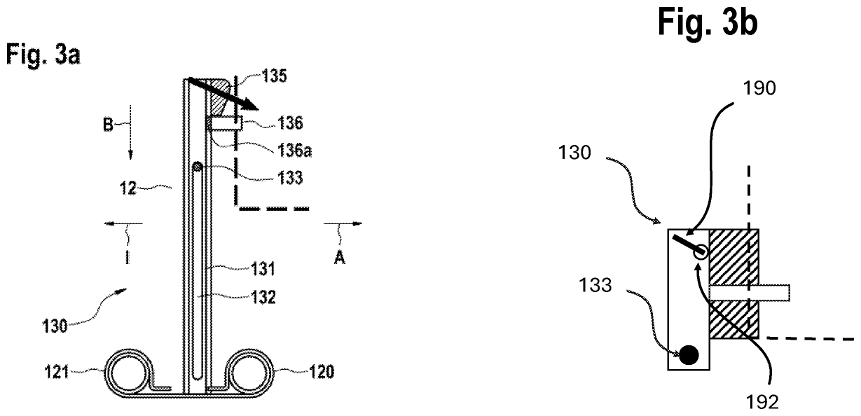

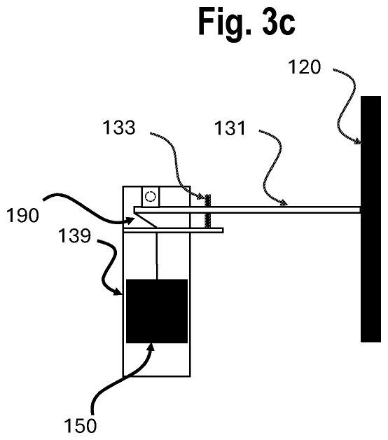

FIG. 3a shows a schematic representation of a first collision detection device 100 according to one embodiment in a top view.

An essential element of the first collision detection device 100 is the first slider element 131. This is connected to the first collision element 120, in particular to the upper section and/or the lower section 121 described above.

This connection allows the first slider element 131 to follow a possible evasive movement of the first collision element 120 in the event of a collision. This creates a guide for the evasive movement of the first collision element 120 (force component parallel to the slider element) between the first collision element 120 and the first detection device 130, which makes it possible to detect a collision.

The first slider element 131 also comprises a first guide device 132, which can be designed as an elongated hole or a comparable opening.

The first slider element 131 can, for example, be made of an originally solid material, such as a metal. The first guide device 132, for example in the form of a slotted hole, can be introduced into this material by milling or another suitable machining method.

Alternatively, the first guide device 132 may also comprise a special insert. Such an insert may consist of a material that has particularly good sliding properties in order to enable low-friction movement within the guide device. For example, a plastic such as PTFE or a similar material may be used for this purpose.

A first bearing element 133 is provided to guide the first slider element 131. This may be, for example, a pin, mandrel, or similar guide element. The bearing element 133 supports the slider element 131—in particular relative to the first sensor element 136 of the detector device 130—and/or guides its movement.

The first bearing element 133 is preferably designed as a round element, as this shape enables particularly smooth and low-friction guidance of the first slider element 131. The diameter of the first bearing element 133 is adapted to the width of the first guide device 132 in the first slider element 131, in particular in the zero position of the slider element 131 shown in FIG. 3a. “Zero position” here means the position of the slider element without any external force acting on the safety device.

In particular, the first bearing element 133 may have a slightly smaller diameter than the width of the first guide device 132 outside the zero position. This deliberately chosen undersize ensures that the first slider element 131 is reliably guided within the first guide device 132, while at the same time preventing the slider element from jamming or snagging. The precise alignment of the bearing element 133 in the zero position with the guide device enables the slider element to be held in the zero position without play.

A first reset device 139 (not shown here) is provided in the first detector device 130, which exerts a first reset force 135 on the slider element 131. This reset force serves to hold the first slider element 131—and thus also the first collision element 120—in a defined starting position, namely in the zero position, before a collision.

To this end, the first reset device 139 (not shown here) exerts a predefined reset force 135 on the first slider element 131 at a predetermined point, thereby determining both the direction and the strength of the reset force.

In principle, the first reset device 139 (not shown here) can be designed as any device that exerts the desired reset force on the first slider element 131. Possible implementations include, for example, spring systems or elastic elements.

However, it has proven to be particularly advantageous to generate the first reset force 135 via a device that exerts a constant reset force on the first slider element 131 by means of a weight (a predetermined mass) and a cable pull 190. This variant has the advantage that the force acting on the first slider element 131 remains the same even when deflected from its rest position, since the weight force acts constantly regardless of the position of the slide element, see FIG. 3c. In this variant, the cable of the cable pull 190 can be fixed with a first end on the side of the slider element 131 facing away from the washing portal. The cable pull can be guided downwards through an opening or guide 192 in the slider element 131, where a second end of the cable is fixed to a weight and exerts the reset force.

The first detector device 130 also comprises a first sensor element 136, which serves to detect a movement of the first slider element 131 and then to output a corresponding sensor signal. The first sensor element 136 can be attached to the portal and serves to detect a relative movement of the slider element 131.

In the event of a collision and the resulting movement of the first slider element 131, the first sensor element 136 detects this movement and transmits an electrical signal to the control unit of the safety device.

In principle, various sensor technologies can be used, provided that they are capable of reliably detecting movement of the first slider element 131 from its rest position. For example, optical systems such as fork light barriers or comparable sensors would also be conceivable. However, due to the harsh operating conditions in a car wash, in particular the swirling of water, dirt, and cleaning agents, mechanical sensor solutions are preferable.

The first sensor element 136 can therefore preferably be designed as a mechanical switch, magnetic switch, or induction switch. A particularly robust and reliable solution is to provide a metallic counterpart 136a on the first slider element 131. In this case, the first sensor element 136, which is an inductive sensor, can detect the movement of this counterpart 136a and then output a corresponding sensor signal.

The first and/or second sensor element 136, 236 can preferably be connected or attached to the washing portal 10 in a fixed or rigid manner in order to detect the movement of the first and/or second slider element 131, 231—and, in the case of an inductive sensor element, in particular a metal counterpart thereto.

The dimensions of the first guide device 132, in particular the length of the elongated hole, are designed to allow sufficient range of motion for the first slider element 131 in the event of a collision.

In particular, the first guide device 132 must allow movement of the first slider element 131 in a range that is at least large enough for the first collision element 120 to perform a complete evasive movement until the stopping process of the washing portal 10 initiated after the collision is complete and the washing portal 10 has come to a complete standstill.

The required length of the first guide device 132 and the design of the first suspension device 110, in particular the distance between the first collision element 120 and the support 12 of the washing portal 10, depend, among other things, on the maximum movement speed of the washing portal 10, the mass of the washing portal 10 that must be braked in the event of a collision, and the properties of the braking systems or control mechanisms used for the stopping process and the friction conditions between the braked wheel and the running rail.

These parameters determine how large the necessary evasive path of the first collision element 120 must be to ensure that a collision of the washing portal 10 with a collision body is reliably avoided.

FIG. 3b shows a schematic representation of the first detector device 130, as shown in FIG. 3a, according to one embodiment in a top view.

The first detector device 130 serves to detect a movement of the first collision element 120 caused by a collision. A first bearing element 133 may be designed to move a first slider element 131 relative to the sensor element of the first detector device 130 in a sliding and/or rotating manner. The first slider element 131 may be connected to the first collision element 120 so that movement of the first collision element 120 is transmitted to the first slider element 131.

The reset force 135 with which the first slider element 131 is held back is transmitted to the slider element by a first cable pull 190 (shown in FIG. 3c). This cable pull 190 is guided downwards through a hole in the detector device 130 to the reset weight 139.

FIG. 3c shows a schematic representation of the first detector device 130 comprising the first reset device 139 in a side view.

The first detector device 130 includes a first reset device 139 which exerts a first reset force 135 on the slider element 131 via the weight force of a reset weight 150 (shown in the figure as a black filled square block). This serves to hold the first slider element 131- and thus also the first collision element 120—in a defined starting position before or after a collision. The rope of the rope pull (also: cable pull) 190 can be fixed with a first end on the side of the slider element 131 facing away from the washing portal. The rope pull 190 can be guided downwards through an opening or guide in the slider element 131, where a second end of the rope is fixed to a reset weight 150 and exerts the reset force.

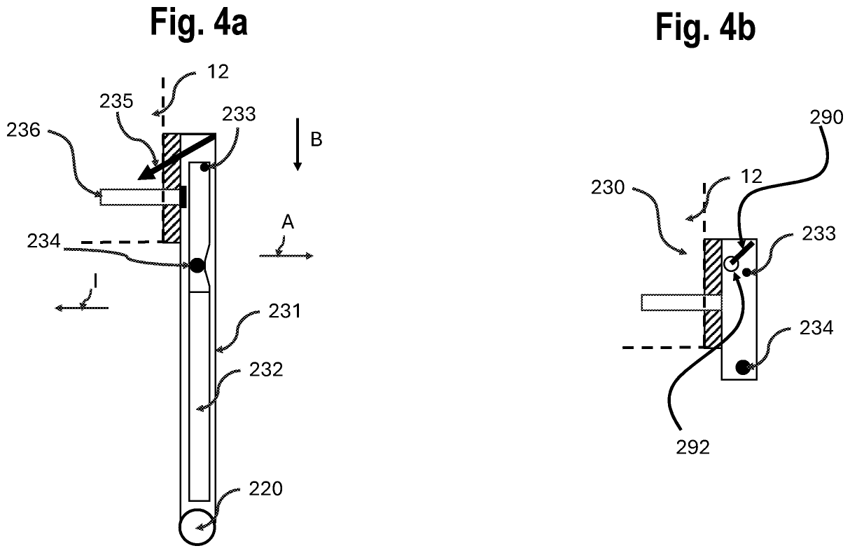

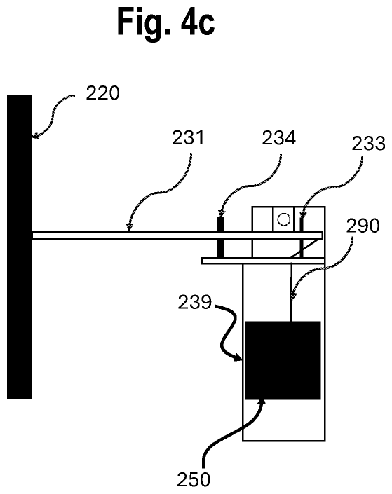

FIG. 4a shows a schematic representation of an embodiment of the second detector device 230. This may represent a modification of the first detector device 130 described above.

The second slider element 231 may be connected to the second collision element 220. This mechanical coupling allows a force acting on the second collision element 220 to cause a corresponding movement of the second slider element 231 relative to or within the second detector device 230.

Analogous to the first detector device 130, the second detector device 230 is also mechanically coupled to a second guide device 232, which may be designed in the form of an elongated hole or a comparable opening. Accordingly, the same technical requirements apply to the second guide device 232 as to the first guide device 132 of the first detector device 130 already described.

In contrast to the first detector device 130, which comprises only a single first bearing element 133, the second detector device 230 may have two second bearing elements 233 and 234. These two second bearing elements 233, 234 are designed as pins, mandrels, or a comparable guide element. Their diameter is adapted to the width of the second guide device 232 or the elongated hole, respectively, in order to ensure precise guidance of the second slider element 231.

The front bearing element 234, which is formed closer to the collision element 220 (also referred to as the first pin), has a diameter that is only slightly smaller than the width of the second guide device 232 in the zero position. This slight clearance ensures that the second slider element 231 cannot perform any significant lateral movement within the second guide device 232 in the zero position. The slight undersize serves only to prevent the second slider element 231 from jamming or becoming stuck during longitudinal movement.

The rear bearing element 233, which is formed further away from the collision element 220 (also referred to as the second pin), on the other hand, has a diameter that can be significantly smaller than the width of the second guide device 232, particularly in the area of the second guide device 232 where the rear bearing element 233 is located in the rest position.

This difference can be achieved in two different ways:

On the one hand, a smaller diameter can be selected for the rear bearing element 233 than for the front bearing element 234. In addition or alternatively, the second guide device 232, in particular the elongated hole, can be designed so that it has greater play in the area of the rear bearing element 233.

The second detector device 230 comprises a second reset device 239 (not shown here), the basic principle of which corresponds to the first reset device 139 (not shown here) described above and which exerts a reset force 235 on the second slider element.

The second reset device is designed to exert a reset force 235 on the second slider element 231 in order to hold it in a defined rest position (also: zero position). In this case, the second slider element 231 is pushed forward in the direction of movement B as far as possible by the combination of the second guide device 232 and the rear second bearing element 233.

In addition, the second reset force 235 can exert a lateral force component on the second slider element 231. This positions the second slider element 231 via the second guide device 232 on the rear bearing element 233 so that it is in the defined rest position. This positioning serves to hold the second slider element 231 in a defined initial position during regular operation of the safety device, but allows it to be deliberately deflected from this rest position when an external force is applied, for example in the event of a collision. This function is illustrated schematically by the direction of the arrow for the second reset force 235 in FIG. 4a.

The arrangement of the second detector device 230 allows the second slider element 231 to perform an inter alia linear displacement when a force is applied, for example in the event of a collision, with a force component opposite to the direction of movement B.

This movement takes place in a direction predetermined by the second guide device 232 and the two second bearing elements 233, 234. Since the second guide device 232 has a slotted hole geometry and the two second bearing elements 233, 234 guide the second slider element 231 therein, the second slider element 231 can be displaced along the longitudinal direction of the slotted hole when a suitable force is applied.

The lateral movement of the second slider element 231, on the other hand, is severely restricted by the use of the two second bearing elements 233, 234. However, a small relative lateral movement is possible, particularly in the zero position, as it is specifically permitted in this area by the play between the rear second bearing element 233 and the width of the second guide device 232.

The dimensions of the second guide device 232 and the rear second bearing element 233 are selected such that this slight lateral movement is sufficient to be reliably detected by the second sensor element 236 when a lateral deflection of the second slider element 231 occurs.

The second detector device 230 comprises a second sensor element 236, which serves to detect a movement of the second slider element 231 and then to output a corresponding sensor signal. The second sensor element 236 can be fixedly formed on the portal and, in the case of an inductive sensor, can be operatively connected to a metallic counterpart on the second slider element 231.

The second sensor element 236 is essentially analogous to the first sensor element 136 of the first detector device 130. It can detect movement of the second slider element 231 in the longitudinal direction as well as lateral movement. Here, too, various sensor technologies are conceivable, with electrical sensors, in particular inductive sensors or mechanical switches, being preferred.

For a detailed description of the possible embodiments and modes of operation of the sensor element, reference is made to the explanations for the first sensor element 136.

Alternatively, the second detector device 230 may also not represent a modification of the first detector device 130 described above and may correspond to the latter except for a design that is mirrored to the center plane.

FIG. 4b shows a detail of the schematic representation of the second detector device 230, as shown in FIG. 4a, according to one embodiment in a top view.

The second detector device 230 may comprise two second bearing elements 233 and 234, which are designed to move the second slider element 231 in a sliding and rotatable manner relative to the second detector device 230.

The reset force 235, with which the slider element 231 is held back, is transmitted to the slider element 231 by the cable pull. This cable pull is guided downwards through an opening, in particular bore 292, in the detector device 230 to the reset weight 250.

FIG. 4c Shows a Schematic Representation of the Second Detector Device 230 Comprising the second reset device 239 in a side view.

The second detector device 230 has a second reset device 239, which exerts a second reset force 235 on the second slider element 231 via the weight force of the reset weight 250. This serves to hold the second slider element 231—and thus also the second collision element 220—in a defined starting position (also: zero position) before or after a collision. The rope of the cable pull 290 can be fixed with a first end on the side of the slider element 231 facing away from the washing portal. The cable pull can be guided downwards through an opening or guide 292 in the slider element 231, where a second end of the cable is fixed to a reset weight 250 and exerts the reset force.

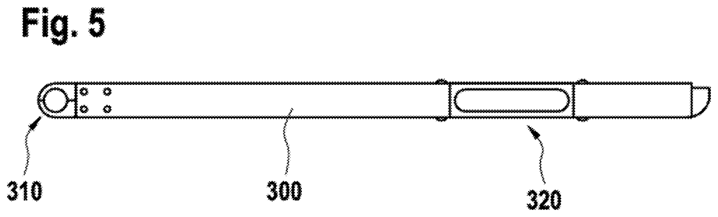

FIG. 5 shows a schematic representation of a coupling element 300 according to one possible embodiment.

As previously described, the coupling element 300 is mechanically coupled to both the first collision element 120 and the second collision element 220. The mechanical coupling is implemented in such a way that the two collision elements 120, 220 can continue to move independently of each other.

As can be seen in FIG. 5, the coupling element 300 comprises a first coupling point 310 at which it is coupled to the first collision element 120. In the embodiment shown here, the first coupling point 310 is designed as a piece of material, for example a plate, in which an opening is made. The first collision element 120 can be passed through this opening, thereby establishing a mechanical coupling between the coupling element 300 and the first collision element 120.

The first coupling point 310 can be designed so that the coupling element 300 does not protrude beyond the outer diameter of the first collision element 120 in the direction of the inner side I, or only to a small extent. This can be achieved, for example, by means of a corresponding groove or recess on the first collision element 120, into which the coupling element 300 is embedded.

However, depending on the design and application, other approaches for a suitable mechanical coupling between the coupling element 300 and the first collision element 120 are also possible. For example, an alternatively shaped fastening structure could be provided.

As can be seen in FIG. 5, the coupling element 300 comprises a second coupling point 320, in particular a slotted hole, at which it can be mechanically coupled to the second collision element 220.

For mechanical coupling, a guide in the form of an elongated hole or a comparable opening can be incorporated into the coupling element 300. This guide allows a defined relative movement of the second collision element 220 within the second coupling point 320, while at the same time ensuring the desired mechanical connection with the coupling element 300.

Alternatively, it is conceivable to integrate a special insert into the coupling element 300 at this point. This insert can also have a guide in the form of an elongated hole or a comparable opening. By using a separate insert, the guide can be specifically optimized, for example by using materials with particularly good sliding properties and low friction.

Such an insert can be made of a suitable metal or a high-quality plastic, for example PTFE (polytetrafluoroethylene) or a comparable material. These materials offer particularly low friction and enable low-friction movement of the second collision element 220 within the guide of the second coupling point 320.

The following figures serve to illustrate the behavior of the safety device in various collision scenarios.

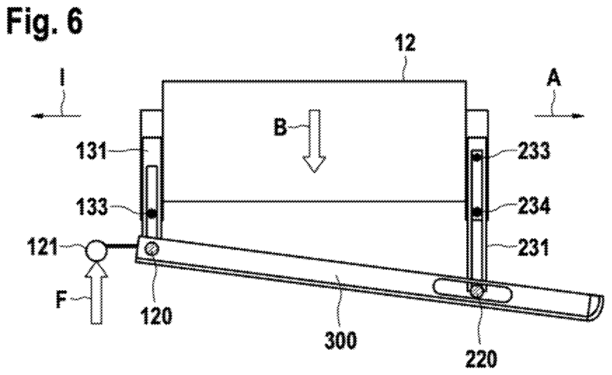

FIG. 6 shows a schematic representation of a collision scenario in the event of a frontal collision with the safety device in the interior area on the side of the first collision element 120. The force F acting in the interior area, in particular on the element 121 of the first collision element 120 offset toward the interior I, is shown as an example. However, the same principle also applies to a collision at another point on the first collision element 120.

The direction of movement of the washing portal 10, including the support 12, is indicated by the reference symbol B, as in the previous figures. The mechanical force F exerted by a collision body or a person in a collision is represented by an arrow. The direction of this arrow also indicates the direction of the force acting on the first collision element 120.

In the scenario shown in FIG. 6, in which the first collision element 120 collides head-on with a collision body, the collision body exerts a force F on the first collision element 120 or on its inwardly offset element 121.

This force causes the first slider element 131 to be displaced in the opposite direction to the direction of movement B of the washing portal 10. As explained above, this displacement can be detected, for example, by the first sensor element 136, which then outputs a corresponding sensor signal.

As can be seen further in FIG. 6, the coupling element 300 rotates slightly during this movement. This allows the first slider element 131 to move independently without changing the position of the second collision element 220 in the second detector device 230.

Due to the rotatable coupling between the coupling element 300 and the first slider element 131, as well as the rotatable and slidable coupling between the coupling element 300 and the second collision element 220, the first collision element 120 can move independently without any movement of the second collision element 220 occurring or being necessary.

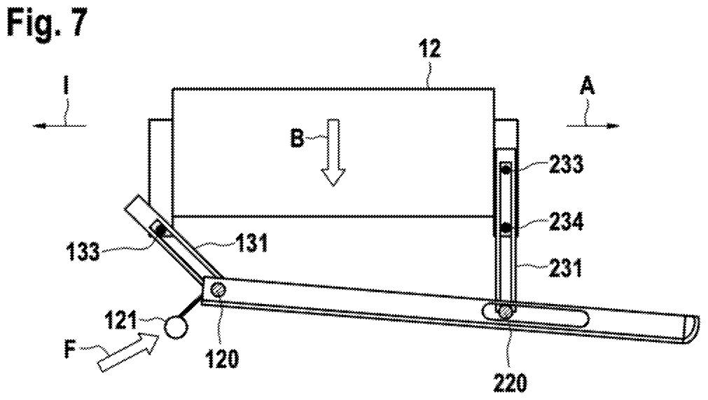

FIG. 7 shows a schematic representation of a collision scenario in which the first collision element 120 collides with a lateral force, in particular a force component acting from the inside I towards the outside A.

In this scenario, which occurs, for example, when the first collision element collides with a slightly open vehicle door, the first collision element 120 will not move exclusively in the direction of the support 12—it will also perform a lateral evasive movement. This lateral movement is made possible in particular by the fact that the first slider element 131 performs a rotational movement around the first bearing element 133.

As can be seen in FIG. 7, the coupling element 300 performs a corresponding compensating movement, which is made possible by the slidable and rotatable coupling to the second collision element 220. As a result, the second collision element 220 remains in its rest position in this case as well, so that the second slider element 231 does not move.

The first slider element performs a rotational movement around the bearing element, in particular the pin 133. As part of this movement, the coupling element is carried along in the connection to the first collision element, whereby the first collision element can rotate freely in the coupling element. The coupling element is coupled to the second collision element via a slotted hole. This connection allows the coupling element to move linearly and rotationally on the second collision element without transmitting any force. The second coupling rod is not affected by the movement of the first coupling rod.

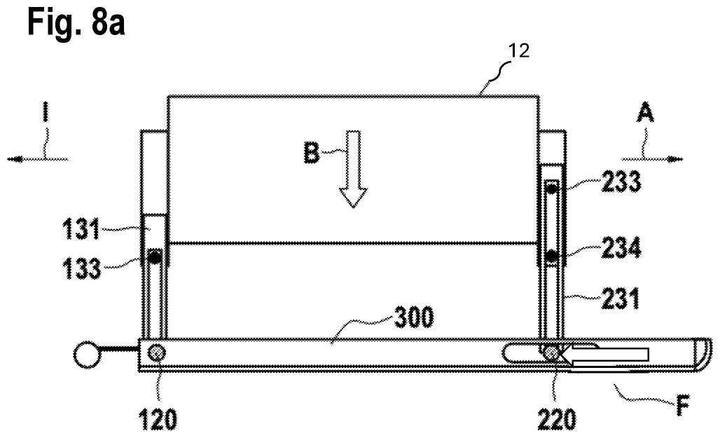

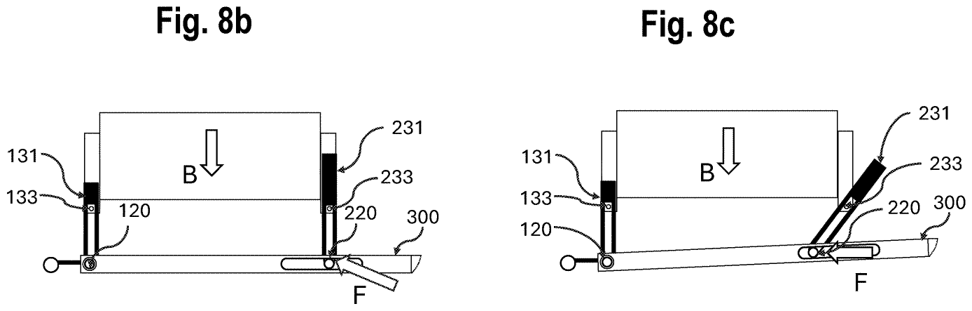

FIG. 8a shows a schematic representation of a collision scenario when a force is applied to the second collision element 220 in a first embodiment of the second detector device with two second pins 233, 234.

When a lateral force F acts from the outside in the direction of the second collision element 220, the second slider element 231 can move minimally to the side. This slight movement is made possible by the rear second bearing element 233, whose diameter is deliberately chosen to be smaller than the width of the second guide device 232 in this area.

Such a collision can occur, for example, when the washing portal 10 approaches a person standing on the outside A. If the person is startled or reflexively reaches toward the second collision element 220, for example, by making an unconscious protective movement with their arm, this can lead to a brief application of force with a lateral component. In this case, the force is detected by the second detector device.

In the first embodiment of the second detector device (two second bearing elements) described here, no significant (rotational) deflection of the slider element is possible and no significant follow-up path is released. However, a follow-up path perpendicular to the slider element (transverse to the travel path) is also not required in this case, as the distance to the edge does not change due to the travel movement of the rollover car wash.

The same movement behavior would result if the force did not act in the same direction on the second collision element 220, but on the coupling element 300. This would transfer the force to the second collision element 120, which is rigidly mounted in this force direction.

FIG. 8b shows a schematic representation of a collision scenario with a force acting on the second collision element 220 in a second embodiment of the second detector device with only a second pin 233.

In this second embodiment, the second slider element 231 is guided in the guide device 232 via only one second bearing element 233—in contrast to the first embodiment of the second detector device according to FIG. 8a, which has two second bearing elements 233, 234, in particular two second pins.

In this embodiment, the second collision detection device 200 behaves like the first collision detection device 100; or rather, it is constructed accordingly-only mirrored about the intermediate center plane.

When a lateral force acts from the outside in the direction of the second collision element 220, the second slider element 231 does not experience any lateral force. The force is transferred to the first collision element 120, which is rigidly mounted in this force direction and therefore does not move.

Such a collision can occur, for example, when the washing portal 10 approaches a person standing on the outside A. If the person is startled or reflexively reaches toward the second collision element 220, for example, by making an unconscious protective movement with their arm, this can lead to a brief application of force with a lateral component. In this special case, the force is not detected by any detector device and no follow-up path is released, which is not necessary, however, due to the force acting transversely to the direction of movement B of a person standing to the side of the portal.

FIG. 8c shows a schematic representation of a collision scenario in the second embodiment of the second detector device with only one pin 233, in particular when a lateral force is exerted on the second collision element 220 in the direction of the first collision element 120, in particular after the latter has performed a movement to compensate for the force exerted on the. In this embodiment of the guide of the second slider element on or along the second detector device, in contrast to the second detector device according to FIG. 8a, the second slider element is coupled to the second detector device only via a second bearing element 233, in particular a second pin.

In this embodiment, the second collision detection device 200 behaves like the first collision detection device 100 and is constructed accordingly, only mirrored about the intermediate center plane.

When a lateral force acts from the outside in the direction of the first collision element 120 on the second collision element 220, the second slider element 231 experiences a lateral force. The second slider element 231 is deflected in the direction of the vehicle (inward). The deflection (rotation) of the second slider element 231 can be detected by the second detector device.

The collision force acts laterally on the second collision element 220, which then pivots around the second bearing element 233. The coupling element 300 is slightly pivoted due to the rotatable guide of the second collision element 220 in the elongated hole of the coupling element. This movement is compensated at the coupling point to the first collision element, with which the collision element is rotatably mounted. The movement of the second collision element is therefore independent of the movement of the first collision element.

FIG. 8b andc each show the second version of the second detector device (with only one second bearing element) with different points of application for the force in essentially the same direction of force. The second slider element is guided by only one second pin instead of two second pins. The other movements of the sensor device shown in FIGS. 6-7 and 9-12 are identical. This is due to the independent movements of the two collision detection devices and the couplings to the coupling element. FIGS. 4a, 4b, 4c, 6, 7, 8a, 9, 10, 11a, 11b, 12a, and 12b each show the first embodiment of the second detector device (with two second bearing elements).

The following figures describe the behavior of the safety device in the event of a collision between a coupling element 300 and a collision object or a person in further collision scenarios.

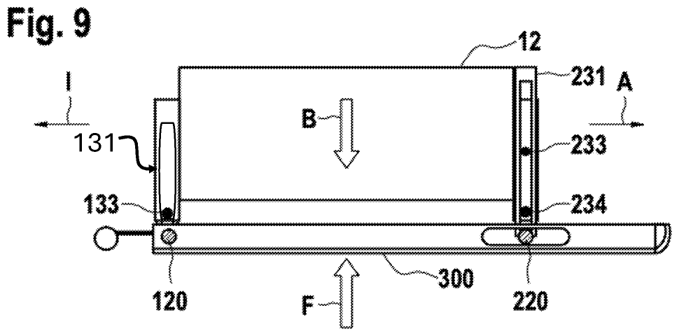

FIG. 9 shows the case in which the collision and the associated force F occur in the intermediate area, in particular at the coupling element 300 approximately in the middle of the area between the first collision element 120 and the second collision element 220.

In such a collision, the coupling element 300 is influenced in the direction of movement B in such a way that both the first collision element 120 and the second collision element 220 are moved accordingly. This causes the two slide elements 131, 231 to move in the opposite direction to the direction of movement B of the washing portal 10. The two slide elements move synchronously when the force is applied centrally and the first and second reset forces are equal in the direction of travel.

As a result, both the first sensor element 136 and the second sensor element 236 are activated, thereby detecting the collision.

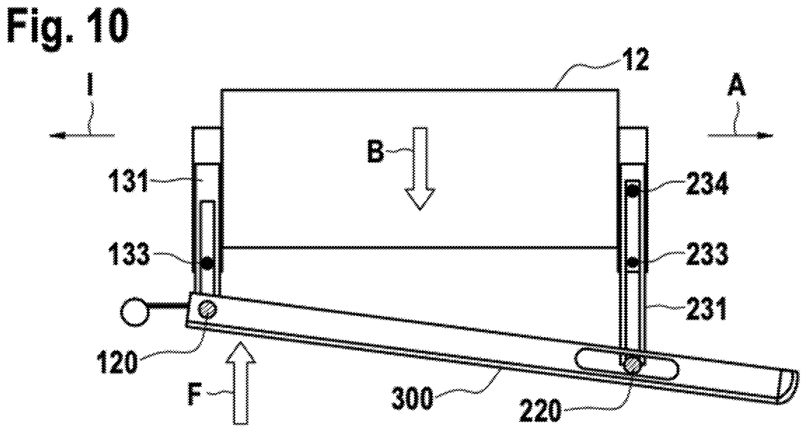

FIG. 10 shows the case in which a collision occurs with the coupling element 300 near the first collision element 120.

In such a collision, only the first slider element 131 is preferably moved backward against the direction of movement B of the washing portal 10. This movement leads to the detection of the collision by the first sensor element 136, which outputs a corresponding sensor signal.

Due to the movable and rotatable coupling between the coupling element 300 and the second collision element 220, the second collision element 220 remains in its rest position. Thus, the second slider element 231 also remains unchanged in its initial position.

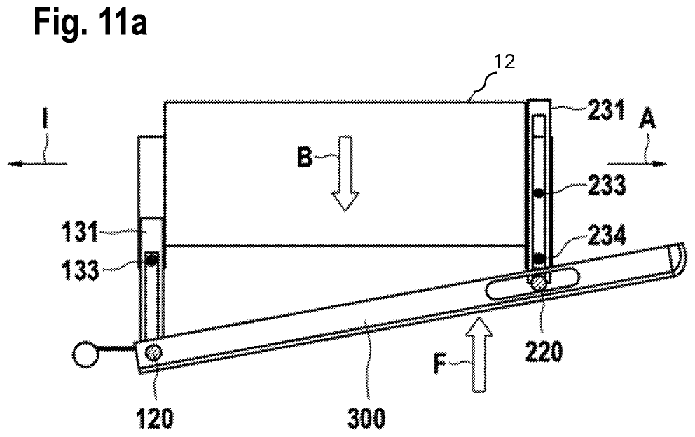

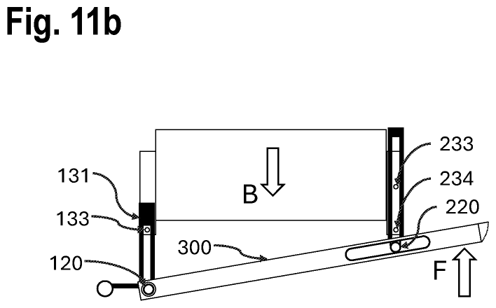

FIG. 11a shows the case in which a collision with the coupling element 300 occurs in the intermediate area, in particular between the first collision element 120 and the second collision element 220, but close to the second collision element 220.

In this scenario, the force F causes the second collision element 220 and thus the second slider element 231 to move in the opposite direction to the direction of movement B of the washing portal 10. This movement is detected by the second sensor element 236, which then outputs a corresponding sensor signal.

The first collision element 120 and the first slider element 131, on the other hand, remain in their rest position. This is made possible by the rotatable coupling between the first collision element 120 and the coupling element 300, as well as by the sliding coupling between the second collision element 220 and the coupling element 300. As a result, the movement remains limited to the second collision element 220 and the second slider element 231.

FIG. 11a shows the first embodiment of the second detector device, in which the second slider element 231 is guided by two second pins 233, 234.

The same behavior of the second slider element 231 under this force is achieved when the second slider element 231 is guided by only one pin (second embodiment of the second detector device). This is due to the coupling of the second collision element 220 in the coupling element 300 via the elongated hole, as a result of which, in this collision, forces can only be transmitted predominantly against the direction of travel and thus no significant force acts on the second collision element 220 in a lateral direction that would twist the second collision element 220.

In the event of a frontal collision with the coupling element 300 in the area between the second collision element 220 and its outer end (i.e., in the outer area), the safety device behaves analogously to the scenario described above in FIG. 11a.

The force F causes the second collision element 220 and thus the second slider element 231 to move in the opposite direction to the direction of movement B of the washing portal 10. This movement is detected by the second sensor element 236, which then outputs a corresponding sensor signal.

The first collision element 120 and the first slider element 131 remain in their rest position, as the rotatable coupling between the first collision element 120 and the coupling element 300 and the slidable coupling between the second collision element 220 and the coupling element 300 restrict movement to the second collision element.

FIG. 11b shows the same case as FIG. 11a, except that the collision at the coupling rod 300 does not take place between the two collision elements, but in the area of the coupling rod that protrudes beyond the outside of the portal, i.e., in the outer area. The direction of force resulting from the collision runs counter to the direction of movement B. The second collision element 220 moves in linearly as in FIG. 11a, which is detected by the sensor element, and the first collision element 120 is independent of this movement.

FIG. 11b shows the first version of the second detector device, namely with two second pins 233, 234.

The same behavior of the second slider element 231 during this force application results when the second slider element 231 is guided with only one pin (second design). This is due to the coupling of the second collision element 220 in the coupling element 300 via the elongated hole, as a result of which only forces predominantly opposite to the direction of travel can be transmitted during this collision and thus no significant force component acts on the second collision element 220 in the lateral direction, which would twist the second collision element 220.

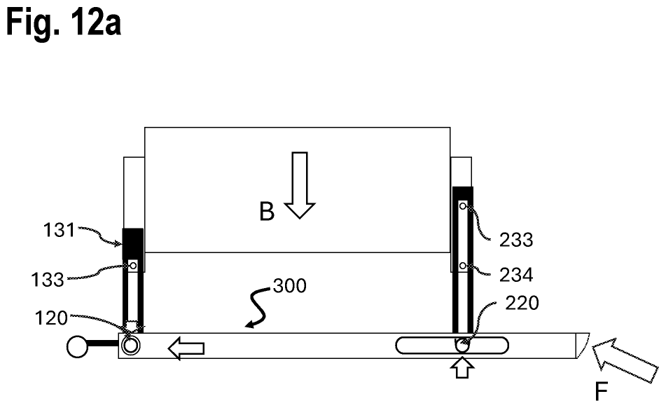

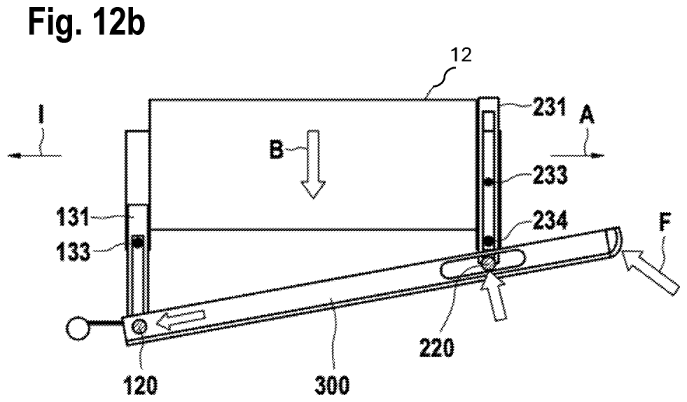

FIG. 12a shows the case in which a mechanical force F acts on the outer end of the outside of the coupling element 300, i.e., also in the outer area. This force can lead to resulting force components, which are indicated in FIG. 12a with additional arrows.

The force resulting from the collision between the collision object and the first or second collision element or the coupling element runs normally to their surface at the point of contact without taking friction effects into account and therefore contains, in addition to the force component opposite to the direction of travel, a force component lateral to the direction of force.

The portion of the force that runs parallel to the direction of movement B of the washing portal 10 is transmitted to the second collision element 220 via the coupling element 300. This causes the second slider element 231 to move in the opposite direction to the direction of movement B, whereby the collision is detected by the second sensor element 236. This portion of the force causes a moment in the coupling element 300 around the second collision element 220. This moment causes a force to act on the first collision element 120, which pushes the first slider element 131 in the direction of travel B. Since the first slider element 131 is already at the end stop in the elongated hole for the pin 133, this force does not cause any movement of the first collision element 120.

The lateral component of the force can be transferred to the first collision element 120. However, due to the design of the first slider element 131, no movement in the direction of the inside I is possible.

FIG. 12a shows the case where the coupling element is in the zero position. The second collision element 220 is touched by the coupling element 300 in the elongated hole. This means that only a portion of the force in the direction opposite to the direction of travel of the guard portal is transferred. The second collision element 220 moves in linearly. Even if the collision force on the coupling element 300 has a significant component in the transverse direction, this does not act on the second slider element 231.

The force in the transverse direction, towards the vehicle, is transmitted entirely to the first collision element 120, which is rigid in this direction of movement.

The bearing elements, in particular pins 233 and 234, are designed so that they have at least a small amount of play within the guide device, in particular in the zero position. Since only one force can be transmitted from the coupling element to the second collision element 220 via the elongated hole, predominantly in the opposite direction to the direction of travel B, the linear guide is not subjected to any transverse force via the pins 233 and 234 and therefore cannot jam due to a collision force on the coupling element.

The second slider element 231 behaves in the same way when subjected to this force if the second slider element 231 is guided by only one pin (second embodiment). This is due to the coupling of the second collision element 220 in the coupling element 300 via the elongated hole, as a result of which only forces predominantly opposite to the direction of travel can be transmitted during this collision and thus no significant force component acts on the second collision element 220 in the lateral direction, which would twist the latter.

FIG. 12b shows the case where the coupling element 300 is tilted by a small angle due to the linear deflection of the second slider element 231. As a result, the direction of the force transmitted from the elongated hole of the coupling element to the second collision element 220 no longer acts exactly against the direction of travel and also has a small force component transverse to the second slider element 231. Since the angle by which the coupling element is tilted is small, this lateral force on the second slider element is small and will therefore not cause the linear guide to jam over two pins.

The coupling element 300 is coupled to the first collision element 120 and the second collision element 220 in such a way that a movement of the coupling element 300 moves the first collision element 120 and/or or the second collision element 220 and does not exert a force on either the first collision element 120 or the second collision element 220 that would cause the guide to jam at the respective detection device or cause jamming in the guides between the coupling element and the collision rods 120 and 220.

The same behavior of the second slider element 231 under this force is obtained when the second slider element 231 is guided by only one pin (second embodiment). This is due to the coupling of the second collision element 220 in the coupling element 300 via the elongated hole, as a result of which only forces predominantly opposite to the direction of travel can be transmitted during this collision and thus no significant force component acts on the second collision element 220 in the lateral direction, which would twist the latter, i.e., the second collision element 220.

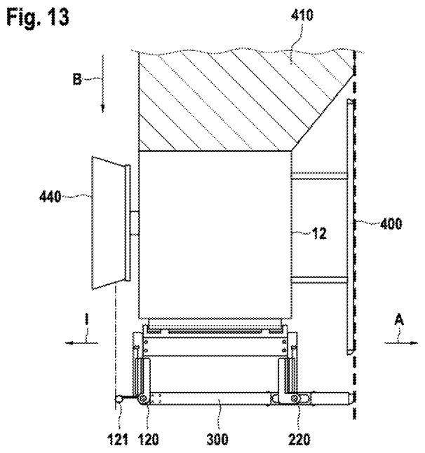

FIG. 13 shows a schematic top view of a support 12 of a car washing portal 10 with a safety device according to one embodiment.

The figure shows that the safety device with the two collision elements 120, 220 and at least one coupling element 300 is located in front of the support 12 in the direction of movement B.

The first collision element 120 has a section 121 which, if necessary, protrudes slightly further towards the inside I. This can serve, for example, to adequately protect an assembly located behind it in the direction of movement, such as a wheel washing brush 440 in this case. Section 121 can protrude as far toward the inside as the rigid elements of the downstream unit also protrude in this direction.

It can also be seen that some components 410 of the washing portal 10 are located towards the outer side A, which protrude rearward in the direction of movement B beyond the width of the support 12. These may be, for example, a splash guard for a washing brush or other protruding components. Accordingly, the coupling element 300 or the coupling elements 300 can protrude at least as far in the direction of the outer side A in order to also sufficiently secure the subsequent protruding components of the washing portal.

In order to prevent, for example, a person from bypassing the upstream coupling elements 300 during operation and then stepping into the space between the coupling element 300 and the downstream protruding components 410, this intermediate area can be secured by suitable protective elements 400, such as rods, grids, or plates.

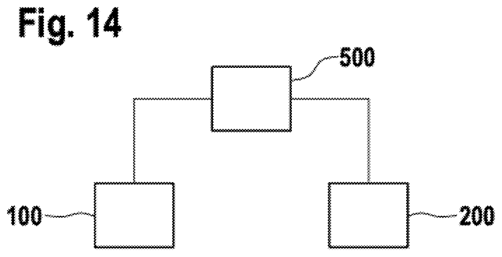

FIG. 14 shows a schematic representation of a block diagram for the control concept of a safety device for a rollover car wash according to one embodiment.

As illustrated in FIG. 14, the first collision detection device 100 and the second collision detection device 200 can each output a signal when a collision event is detected. This signal is transmitted in particular to a control device 500.

If the control device 500 receives such a signal from at least one of the collision detection devices, it can then initiate an emergency shutdown of the rollover car wash. Alternatively, the movement of the washing portal 10 can be stopped.

In a simple variant, the washing portal can be stopped by switching off the drive. Alternatively, an active braking process can be initiated to bring the movement of the washing portal to a halt more quickly. Such active braking can further increase safety by shortening the braking distance and thus reducing the risk of damage or injury in the event of a collision.

The control device 500 can either be integrated into the overall control system of the rollover car wash or designed as a separate control unit.

In the integrated version, the control device 500 processes the signals from the collision detection devices 100, 200 within the general control architecture of the car wash and can communicate directly with the other control components.

Alternatively, the control device 500 can be implemented as a stand-alone control unit that operates independently of the main control system of the car wash. This decentralized solution can further increase safety, as it can continue to operate reliably even if a malfunction occurs in the higher-level control system of the rollover car wash.

The control device 500 can be implemented at least partially in software. In this case, it comprises a corresponding computer program stored in a non-volatile memory. This program can be loaded and executed by a processor, for example a microcontroller, in order to implement the necessary control and safety functions.

Alternatively, the control device 500 can be implemented on a hardware basis with discrete electrical and electronic components. For example, resistors, diodes, transistors, relays, or integrated circuits can be used to evaluate the signals from the collision detection devices 100, 200 and to issue the corresponding control commands for the emergency shutdown of the washing portal 10.

In a hybrid design, the control device 500 can combine both hardware-based safety mechanisms and software-based control algorithms to ensure a robust and fault-tolerant safety architecture.

The present invention provides a safety device for a rollover car wash system that enables early detection of collisions with a collision body, in particular a person. The safety device comprises a first and a second collision detection device, each comprising a collision element and a detector device. The detector devices allow displacement of the collision elements to be detected when force is applied, so that a collision can be detected.

At least one coupling element mechanically connects the two collision elements, whereby the mechanical coupling is designed so that the collision elements can move independently of each other. At the same time, the coupling element allows a force acting on the coupling element to be transmitted to at least one of the collision elements, whereby a collision with the coupling element can also be reliably detected.

A control device receives signals from the collision detection devices and can stop the movement of the washing portal in the event of a detected collision in order to prevent damage or injury. The control device can be integrated into the overall control system of the washing system or designed as a separate control unit to ensure additional safety.

The combination of local collision detection devices and coupling elements enables effective detection of an extended danger zone, thereby improving the safety of the washing portal, particularly with regard to the protection of persons.

In summary, the present invention thus relates to a safety device for a rollover car wash with a washing portal that can be moved along a direction of movement. The device comprises a first and a second collision detection device, each of which contains a collision element and a detector device. The detector devices are mechanically coupled to the collision elements and designed to enable horizontal displacement (including rotational or translational movement of the slider elements) of the collision elements or of slider elements firmly connected to them when force is applied, and to detect this movement.

At least one coupling element connects the two collision elements in a mechanically movable manner and transmits a mechanical force acting on the coupling element at least partially to one or both collision elements. This allows a collision to be detected both directly at the collision elements and at the coupling element, enabling early detection of obstacles or persons in the movement range of the washing portal.

At least one coupling element, in particular a horizontal coupling element, connects the two collision elements, in particular vertical collision elements, in a mechanically movable manner and transmits a mechanical force acting on the coupling element, in particular caused by a collision of the safety device with a collision body, at least partially to one or both collision elements. This allows a collision to be detected both directly at the collision elements and at the coupling element, enabling early detection of obstacles or persons in the movement range of the washing portal.

1. Safety device for a portal car wash with a washing portal (10) that can be moved along direction of movement (B), which is designed in particular to prevent a collision between the portal car wash or its components and a collision body, wherein the safety device comprises:
a first collision detection device (100) with
a first collision element (120); and
a first detector device (130) which is mechanically coupled to the first collision element (120) and which is designed to enable a preferably horizontal displacement of the first collision element (120) when a mechanical force (F) acts on the first collision element (120) and to detect the application of the mechanical force (F) to the first collision element (120);
a second collision detection device (200) with
a second collision element (220); and
a second detector device (230) which is mechanically coupled to the second collision element (220) and which is designed to enable a preferably horizontal displacement of the second collision element (220) against the direction of movement (B) of the washing portal (10) and to detect the application of the mechanical force (F) to the second collision element (220);
at least one coupling element (300), each of which is mechanically coupled to the first collision element (120) and the second collision element (220), wherein the at least one coupling element (300) is movably coupled to the first collision element (120) and the second collision element (220) and is designed to transmit at least part of the mechanical force (F) acting on the coupling element (300) to at least partially transfer the mechanical force (F) acting on the coupling element (300) to the first collision element (120) and/or the second collision element (220), in particular when the coupling element (300) collides with at least one collision body.

2. Safety device according to claim 1,
wherein the mechanical coupling between the first collision element (120) and the at least one coupling element (300) and the mechanical coupling between the second collision element (220) and the at least one coupling element (300) are each designed in such a way that the first collision element (120) and the second collision element (220) can move independently of each other when a mechanical force (F) is applied to the respective collision element (120, 220).

3. Safety device according to one of the preceding claims,
wherein the at least one coupling element (300) is coupled to the first collision element (120) in a rotatable manner, in particular in a substantially horizontal rotatable manner, in particular in a rotatable manner about a vertical axis; and/or
wherein the at least one coupling element (300) is coupled to the second collision element (220) in a displaceable manner, in particular in a substantially rotatable and horizontally displaceable manner.

4. Safety device according to one of the preceding claims,
wherein the at least one coupling element (300) terminates on an inner side (I) facing an object to be cleaned and on which the first collision detection device (100) is provided, preferably substantially flush with the first collision element (120).

5. Safety device according to one of the preceding claims,
wherein the at least one coupling element (300) protrudes beyond the second collision element (220) by a predetermined amount on an outer side (A) facing the inner side (I) and on which the second collision detection device (200) is provided.

6. Safety device according to one of the preceding claims,
wherein the safety device comprises at least two coupling elements (300).

7. Safety device according to one of the preceding claims,
wherein the first collision detection device (100) comprises a first suspension device (110) which is arranged above the first collision element (120) and is designed to hold the first collision element (120) so that it hangs down vertically and can perform a horizontal pendulum movement, in particular a pendulum movement substantially in a horizontal plane, relative to the first suspension device (110); and/or
wherein the second collision detection device (200) comprises a second suspension device (210) which is arranged above the second collision element (220) and is designed to hold the second collision element (220) so that it hangs down vertically and can perform a horizontal pendulum movement, in particular a pendulum movement essentially in a horizontal plane, relative to the second suspension device (210).

8. Safety device according to one of the preceding claims,
wherein the first detector device (130) comprises a first slider element (131) which is mechanically connected to the first collision element (120) and which is designed to perform a linear movement relative to the washing portal (10) against its direction of movement (B) when a force with a vectorial component is applied against the direction of movement (B) of the washing portal (10) (B) and/or, when a force with a vectorial component perpendicular to the direction of movement (B) of the washing portal (10) is applied, to perform a pivoting movement, in particular a pivoting movement away from an object (20) to be cleaned; and/or
wherein the second detector device (230) comprises a second slider element (231) which is mechanically connected to the second collision element (220), and which is designed to perform a linear movement relative to the washing portal (10) against its direction of movement (B) when a force with a vectorial component opposite to the direction of movement (B) of the washing portal (10) is applied, but does not perform any significant pivoting movement when a force with a horizontal vector component perpendicular to the direction of movement (B) of the washing portal (10) is applied.

9. Safety device according to one of claims 1 to 7,
wherein the first detector device (130) comprises a first slider element (131) which is mechanically connected to the first collision element (120) and which is designed to perform a linear movement ( ) relative to the washing portal (10) against its direction of movement (B) when a force with a vectorial component is applied against the direction of movement (B) of the washing portal (10) (B) and/or, when a force with a vectorial component perpendicular to the direction of movement (B) of the washing portal (10) is applied, to perform a pivoting movement, in particular a pivoting movement away from an object (20) to be cleaned; and/or
wherein the second detector device (230) comprises a second slider element (231) which is mechanically connected to the second collision element (220) and which is designed to perform a linear movement relative to the washing portal (10) against the direction of movement (B) of the washing portal (10) when a force with a vectorial component is applied against the direction of movement (B) of the washing portal (10) (B) and/or, when a force with a horizontal vector component perpendicular to the direction of movement (B) of the washing portal (10) is applied, to perform a pivoting movement, in particular a pivoting movement toward an object (20) to be cleaned.

10. Safety device according to claim 8 or 9,
wherein a maximum distance of the linear movement of the first slider element (131) and/or the second slider element (231) when a force with a vector component is applied against the direction of movement (B) of the washing portal (10) is greater than a braking distance of the washing portal (10).

11. Safety device according to one of the preceding claims 8 to 10,
wherein the first detector device (130) comprises a first reset device (139) which holds the first slider element (131) in a starting position with a predetermined reset force (135), in particular as long as no external force acts on the first slider element (131), and/or
wherein the second detector device (230) comprises a second reset device (239) which holds the second slider element (231) in a starting position with a predetermined reset force (235), in particular as long as no external force acts on the second slider element (231).

12. Safety device according to one of the preceding claims 8 to 11,
wherein the first slider element (131) is guided in a first guide device (132) with a first elongated hole or a comparable first opening, and wherein the first slider element (131) is mounted in the first guide device (132) by a first bearing element (133), in particular a first pin, in the first guide device (132) and can perform a longitudinal movement as well as a pivoting movement.

13. Safety device according to one of the preceding claims 8 to 12, wherein the second slider element (231) is guided in a second guide device (232) with a second elongated hole or a comparable second opening, and wherein the second slider element (231) is supported by two second bearing elements (233, 234), in particular two second pins, in the second guide device (232), wherein the two second bearing elements (233, 234) essentially allow a linear movement of the second slider element (231).

14. Safety device according to claim 13,
wherein at least one of the two second bearing elements (233, 234) has a reduced diameter compared to the second guide device (232) in order to allow limited lateral relative movement.

15. Safety device according to one of the preceding claims,
wherein the first collision element (120) at least partially reflects a contour for a maximum treatment space for the object to be cleaned and, in particular, has an adapted shape in areas with lateral aggregates or other components of the portal car wash.

16. Safety device according to one of the preceding claims,
wherein the at least one coupling element (300) has a lateral extension in the direction of the outside (A) which extends beyond the vertical projection of a support (12) of the washing portal (10) in order to cover, in particular, laterally protruding assemblies or other components of the washing portal (10).

17. Safety device according to one of the preceding claims,
wherein the first collision detection device (100) comprises a first sensor element (136) designed to detect movement of the first collision element (120),
and wherein the second collision detection device (200) comprises a second sensor element (236) adapted to detect movement of the second collision element (220).

18. Safety device according to one of the preceding claims,
with a control device (500) designed to stop the movement of the washing portal (10) if movement of the first collision element (120) or the second collision element (220) is detected.

19. Washing portal (10) with a safety device according to one of the preceding claims.

20. Washing portal (10) according to claim 19,
wherein at least one protective element (400) in the form of a rod, plate or comparable element is provided between the second collision element (220) with the coupling elements (300) and components of the washing portal (10) arranged further rearward in the direction of movement (B), which protective element extends at least partially between these components.

21. Portal car wash with a washing portal (10) according to one of claims 19 or 20.
